(19) United States
(12) Patent Application Publication
(10) Pub. No.: US 2018/0260051 A1
(43) Pub. Date: Sep. 13, 2018

(54) PRESSURE DETECTOR FOR PERFORMING PRESSURE DETECTION ACCURACY CORRECTION, AND TOUCH INPUT DEVICE

(71) Applicant: HiDeep Inc., Gyeonggi-do (KR)

(72) Inventor: Se Yeob Kim, Gyeonggi-do (KR)

(21) Appl. No.: 15/771,455

(22) PCT Filed: Oct. 28, 2016
(86) PCT No.: PCT/KR2016/012268

§ 371 Date: Apr. 27, 2018

(30) Foreign Application Priority Data
Oct. 30, 2015 (KR) 10-2015-0152233

(51) Int. Cl. G06F 3/044; G06F 3/0488; G06F 3/045; G06F 3/041

(52) U.S. Cl. CPC G06F 3/044; G06F 3/0412; G06F 3/045; G06F 3/0488

(57) ABSTRACT

A touch input device may be provided that includes: a pressure sensor; and a pressure detector. The pressure detector includes: a drive unit which applies a drive signal to the pressure sensor; a sensing unit which receives the signal from the pressure sensor and detects a capacitance generated at the pressure sensor; a pressure magnitude determination unit which determines a pressure magnitude on the basis of the signal input from the sensing unit; and a controller which performs correction for changing the capacitance corresponding to a predetermined pressure magnitude determined by the pressure magnitude determination unit.

### TECHNICAL FIELD

The present disclosure relates to a pressure detector performing a pressure detection accuracy correction method and a touch input device, and more particularly to a pressure detection accuracy correction method which is applied to a touch input device, examines the touch pressure accuracy, and corrects the accuracy if necessary, a pressure detector performing the method, and the touch input device including the pressure detector.

### BACKGROUND ART

Various kinds of input devices are being used to operate a computing system. For example, the input device includes a button, key, joystick and touch screen. Since the touch screen is easy and simple to operate, the touch screen is increasingly being used to operate the computing system.

The touch screen may constitute a touch surface of a touch input device including a touch sensor panel which may be a transparent panel including a touch-sensitive surface. The touch sensor panel is attached to the front side of a display screen, and then the touch-sensitive surface may cover the visible side of the display screen. The touch screen allows a user to operate the computing system by simply touching the touch screen by a finger, etc. Generally, the computing system recognizes the touch and a position of the touch on the touch screen and analyzes the touch, and thus, performs the operations in accordance with the analysis.

There has been increasing demand for the touch input device detecting not only the touch position but a pressure magnitude of the touch is increasing. In addition to this, there is a requirement for the improvement of the pressure detection accuracy of the touch in the touch input device.

### DISCLOSURE

### Technical Problem

An object of the present invention is to provide a pressure detection accuracy correction method capable of improving the pressure detection accuracy of a touch in a touch input device and to provide a pressure detector performing the same.

Another object of the present invention is to provide a touch input device including the pressure detector performing the pressure detection accuracy correction method.

### Technical Solution

One embodiment is a touch input device that includes: a pressure sensor; and a pressure detector. The pressure detector includes: a drive unit which applies a drive signal to the pressure sensor; a sensing unit which receives the signal from the pressure sensor and detects a capacitance generated at the pressure sensor; a pressure magnitude determination unit which determines a pressure magnitude on the basis of the signal input from the sensing unit; and a controller which performs correction for changing the capacitance corresponding to a predetermined pressure magnitude determined by the pressure magnitude determination unit.

Another embodiment is a pressure detector that includes: a drive unit which applies a drive signal to a pressure sensor; a sensing unit which receives the signal from the pressure sensor and detects a capacitance generated at the pressure sensor; a pressure magnitude determination unit which determines a pressure magnitude on the basis of the signal input from the sensing unit; and a controller which performs correction for changing the capacitance corresponding to a predetermined pressure magnitude determined by the pressure magnitude determination unit.

### Advantageous Effects

According to the embodiment of the present invention, it is possible to provide a pressure detection accuracy correction method capable of improving the pressure detection accuracy of a touch in a touch input device and to provide a pressure detector performing the same.

According to the embodiment of the present invention, it is possible to provide a touch input device including the pressure detector performing the pressure detection accuracy correction method.

According to the embodiment of the present invention, it is possible to prevent the pressure detection accuracy from being degraded due to the deformation of the component, etc., of the touch input device.

According to the embodiment of the present invention, it is possible to provide a pressure detection module capable of improving the signal to noise ratio (SNR) at the time of detecting the pressure.

According to the embodiment of the present invention, it is possible to improve the pressure detection uniformity.

### DESCRIPTION OF DRAWINGS

FIG. 1 is a schematic view showing a configuration of a capacitive touch sensor panel and operations thereof in accordance with an embodiment of the present invention;

FIGS. 2a to 2e are conceptual views illustratively showing a relative position of the touch sensor panel with respect to a display panel in a touch input device according to the embodiment of the present invention;

FIG. 3a is a cross sectional view of the touch input device of a first example which is configured to detect a touch position and a touch pressure in accordance with the embodiment of the present invention;

FIG. 3b is a cross sectional view of the touch input device of a second example which is configured to detect the touch position and the touch pressure in accordance with the embodiment of the present invention;

FIG. 3c shows an optical layer of a backlight unit in the touch input device according to the embodiment of the present invention;

FIG. 3d is a cross sectional view of the touch input device of a third example which is configured to detect the touch position and the touch pressure in accordance with the embodiment of the present invention;

FIGS. 4a and 4b show a relative distance between a pressure sensor and a reference potential layer included in the touch input device of the first example and show that a pressure has been applied to the reference potential layer;

FIGS. 4c and 4d show a relative distance between the pressure sensor and the reference potential layer included in the touch input device of the second example and show that a pressure has been applied to the tough input device;

FIG. 4e shows the arrangement of the pressure sensor included in the touch input device of the third example;

FIGS. 5a to 5e show patterns according to the first example to the fifth examples of an electrode constituting the pressure sensor according to the embodiment of the present invention;

FIG. 6a is a cross sectional view of an exemplary electrode sheet including the pressure electrode for being attached to the touch input device according to the embodiment of the present invention;

FIG. 6b is a cross sectional view of a portion of the touch input device to which the electrode sheet has been attached according to a first method;

FIG. 6c is a plan view of the electrode sheet for being attached to the touch input device by the first method;

FIG. 6d is a cross sectional view of a portion of the touch input device to which the electrode sheet has been attached according to a second method;

FIG. 7a shows a cross section of a portion of the touch input device to which the pressure sensor of which the pressure detection accuracy can be corrected according to a first embodiment has been attached;

FIG. 7b shows a cross section of a portion of the touch input device to which the pressure sensor of which the pressure detection accuracy can be corrected according to a second embodiment has been attached;

FIG. 8a is a plan view of the pressure sensor according to the first embodiment of the present invention;

FIG. 8b is a plan view of the pressure sensor according to the second embodiment of the present invention;

FIG. 9a shows a pressure detector according to the embodiment of the present invention;

FIG. 9b shows a sensing unit of the pressure detector according to the embodiment of the present invention;

FIGS. 10a and 10b are cross sectional views of a portion of the touch input device in which non-uniformity of the pressure detection accuracy may occur; and

FIGS. 11a to 11f are cross sectional views of a portion of the touch input device including the pressure sensor capable of improving the uniformity of the pressure detection.

### MODE FOR INVENTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Similar reference numerals in the drawings designate the same or similar functions in many aspects.

Hereinafter, a pressure sensor and a touch input device to which a pressure detection module including the pressure sensor can be applied will be described with reference to the drawings in accordance with an embodiment of the present invention. While a capacitive touch sensor panel 100 and pressure sensors 450 and 460 are exemplified below, a technique capable of detecting a touch position and/or a touch pressure in a different manner according to the embodiment can be applied.

FIG. 1 is a schematic view showing a configuration of the capacitive touch sensor panel 100 and operations thereof in accordance with an embodiment of the present invention. Referring to FIG. 1, a touch sensor panel 100 according to the embodiment may include a plurality of drive electrodes TX1 to TXn and a plurality of receiving electrodes RX1 to RXm. The touch sensor panel 100 may include a drive unit 120 which applies a drive signal to the plurality of drive electrodes TX1 to TXn for the purpose of the operation of the touch sensor panel 100, and a sensing unit 110 which detects whether the touch has occurred or not and/or the touch position by receiving a sensing signal including information on the capacitance change amount changing according to the touch on the touch surface of the touch sensor panel 100.

As shown in FIG. 1, the touch sensor panel 100 may include the plurality of drive electrodes TX1 to TXn and the plurality of receiving electrodes RX1 to RXm. While FIG. 1 shows that the plurality of drive electrodes TX1 to TXn and the plurality of receiving electrodes RX1 to RXm of the touch sensor panel 100 form an orthogonal array, the present invention is not limited to this. The plurality of drive electrodes TX1 to TXn and the plurality of receiving electrodes RX1 to RXm has an array of arbitrary dimension, for example, a diagonal array, a concentric array, a 3-dimensional random array, etc., and an array obtained by the application of them. Here, “n” and “m” are positive integers and may be the same as each other or may have different values. The magnitude of the value may be changed depending on the embodiment.

As shown in FIG. 1, the plurality of drive electrodes TX1 to TXn and the plurality of receiving electrodes RX1 to RXm may be arranged to cross each other. The drive electrode TX may include the plurality of drive electrodes TX1 to TXn extending in a first axial direction. The receiving electrode RX may include the plurality of receiving electrodes RX1 to RXm extending in a second axial direction crossing the first axial direction.

In the touch sensor panel 100 according to the embodiment of the present invention, the plurality of drive electrodes TX1 to TXn and the plurality of receiving electrodes RX1 to RXm may be formed in the same layer. For example, the plurality of drive electrodes TX1 to TXn and the plurality of receiving electrodes RX1 to RXm may be formed on the same side of an insulation layer (not shown). Also, the plurality of drive electrodes TX1 to TXn and the plurality of receiving electrodes RX1 to RXm may be formed in different layers. For example, the plurality of drive electrodes TX1 to TXn and the plurality of receiving electrodes RX1 to RXm may be formed on both sides of one insulation layer (not shown) respectively, or the plurality of drive electrodes TX1 to TXn may be formed on a side of a first insulation layer (not shown) and the plurality of receiving electrodes RX1 to RXm may be formed on a side of a second insulation layer (not shown) different from the first insulation layer.

The plurality of drive electrodes TX1 to TXn and the plurality of receiving electrodes RX1 to RXm may be made of a transparent conductive material (for example, indium tin oxide (ITO) or antimony tin oxide (ATO) which is made of tin oxide (SnO₂), and indium oxide (In₂O₃), etc.), or the like. However, this is only an example. The drive electrode TX and the receiving electrode RX may be also made of another transparent conductive material or an opaque conductive material. For instance, the drive electrode TX and the receiving electrode RX may include at least any one of silver ink, copper, and carbon nanotube (CNT). Also, the drive electrode TX and the receiving electrode RX may be made of metal mesh or nano silver.

The drive unit 120 according to the embodiment of the present invention may apply the drive signal to the drive electrodes TX1 to TXn. In the embodiment of the present invention, one drive signal may be sequentially applied at a time to the first drive electrode TX1 to the n-th drive electrode TXn. The drive signal may be applied again repeatedly. This is only an example. The drive signal may be applied to the plurality of drive electrodes at the same time in accordance with the embodiment.

Through the receiving electrodes RX1 to RXm, the sensing unit 110 receives a sensing signal including information on a capacitance (Cm) 101 generated between the receiving electrodes RX1 to RXm and the drive electrodes TX1 to TXn to which the drive signal has been applied, thereby detecting whether or not the touch has occurred and where the touch has occurred. For example, the sensing signal may be a signal coupled by the capacitance (CM) 101 generated between the receiving electrode RX and the drive electrode TX to which the drive signal has been applied. As such, the process of sensing the drive signal applied from the first drive electrode TX1 to the n-th drive electrode TXn through the receiving electrodes RX1 to RXm can be referred to as a process of scanning the touch sensor panel 100.

For example, the sensing unit 110 may include a receiver (not shown) which is connected to each of the receiving electrodes RX1 to RXm through a switch. The switch becomes the on-state in a time interval during which the signal of the corresponding receiving electrode RX is sensed, thereby allowing the receiver to sense the sensing signal from the receiving electrode RX. The receiver may include an amplifier (not shown) and a feedback capacitor coupled between the negative (−) input terminal of the amplifier and the output terminal of the amplifier, i.e., coupled to a feedback path. Here, the positive (+) input terminal of the amplifier may be connected to the ground or a reference voltage. Also, the receiver may further include a reset switch which is connected in parallel with the feedback capacitor. The reset switch may reset the conversion from current to voltage that is performed by the receiver. The negative input terminal of the amplifier is connected to the corresponding receiving electrode RX and receives and integrates a current signal including information on the capacitance (CM) 101, and then converts the integrated current signal into voltage. The sensing unit 110 may further include an analog to digital converter (ADC) (not shown) which converts the integrated data by the receiver into digital data. Later, the digital data may be input to a processor (not shown) and processed to obtain information on the touch on the touch sensor panel 100. The sensing unit 110 may include the ADC and processor as well as the receiver.

A controller 130 may perform a function of controlling the operations of the drive unit 120 and the sensing unit 110. For example, the controller 130 generates and transmits a drive control signal to the drive unit 120, so that the drive signal can be applied to a predetermined drive electrode TX1 at a predetermined time. Also, the controller 130 generates and transmits the drive control signal to the sensing unit 110, so that the sensing unit 110 may receive the sensing signal from the predetermined receiving electrode RX at a predetermined time and perform a predetermined function.

In FIG. 1, the drive unit 120 and the sensing unit 110 may constitute a touch detection device (not shown) capable of detecting whether or not the touch has occurred on the touch sensor panel 100 according to the embodiment of the present invention and/or the touch position. The touch detection device according to the embodiment of the present invention may further include the controller 130. The touch detection device according to the embodiment of the present invention may be integrated and implemented on a touch sensing integrated circuit (IC) (not shown) in a touch input device 1000 including the touch sensor panel 100. The drive electrode TX and the receiving electrode RX included in the touch sensor panel 100 may be connected to the drive unit 120 and the sensing unit 110 included in the touch sensing IC through, for example, a conductive trace and/or a conductive pattern printed on a circuit board, or the like. The touch sensing IC may be placed on a circuit board on which the conductive pattern has been printed. According to the embodiment, the touch sensing IC may be mounted on a main board for operation of the touch input device 1000.

As described above, a capacitance (C) with a predetermined value is generated at each crossing of the drive electrode TX and the receiving electrode RX. When an object such as finger approaches close to the touch sensor panel 100, the value of the capacitance may be changed. In FIG. 1, the capacitance may represent a mutual capacitance (Cm). The sensing unit 110 senses such electrical characteristics, thereby being able to sense whether the touch has occurred on the touch sensor panel 100 or not and the touch position. For example, the sensing unit 110 is able to sense whether the touch has occurred on the surface of the touch sensor panel 100 comprised of a two-dimensional plane consisting of a first axis and a second axis and/or the touch position.

More specifically, when the touch occurs on the touch sensor panel 100, the drive electrode TX to which the drive signal has been applied is detected, so that the position of the second axial direction of the touch can be detected. Likewise, when the touch occurs on the touch sensor panel 100, a capacitance change is detected from the reception signal received through the receiving electrode RX, so that the position of the first axial direction of the touch can be detected.

The mutual capacitance type touch sensor panel as the touch sensor panel 100 has been described in detail in the foregoing. However, in the touch input device 1000 according to the embodiment of the present invention, the touch sensor panel 100 for detecting whether or not the touch has occurred and the touch position may be implemented by using not only the above-described method but also any touch sensing method like a self-capacitance type method, a surface capacitance type method, a projected capacitance type method, a resistance film method, a surface acoustic wave (SAW) method, an infrared method, an optical imaging method, a dispersive signal technology, and an acoustic pulse recognition method, etc.

Hereinafter, a component corresponding to the drive electrode TX and the receiving electrode RX for detecting whether or not the touch has occurred and/or the touch position can be referred to as a touch sensor.

In the touch input device 1000 according to the embodiment of the present invention, the touch sensor panel 100 for detecting the touch position may be positioned outside or inside a display panel 200A. The display panel 200A of the touch input device 1000 according to the embodiment of the present invention may be a display panel included in a liquid crystal display (LCD), a plasma display panel (PDP), an organic light emitting diode (OLED), etc. Accordingly, a user may perform the input operation by touching the touch surface while visually identifying an image displayed on the display panel. Here, the display panel 200A may include a control circuit which receives an input from an application processor (AP) or a central processing unit (CPU) on a main board for the operation of the touch input device 1000 and displays the contents that the user wants on the display panel. Here, the control circuit for the operation of the display panel 200A may include a display panel control IC, a graphic controller IC, and other circuits required to operate the display panel 200A.

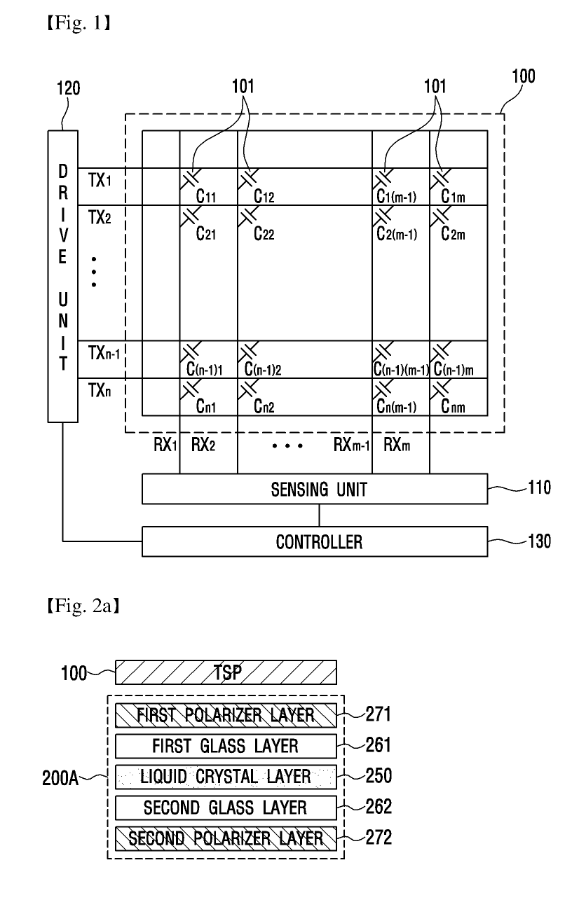

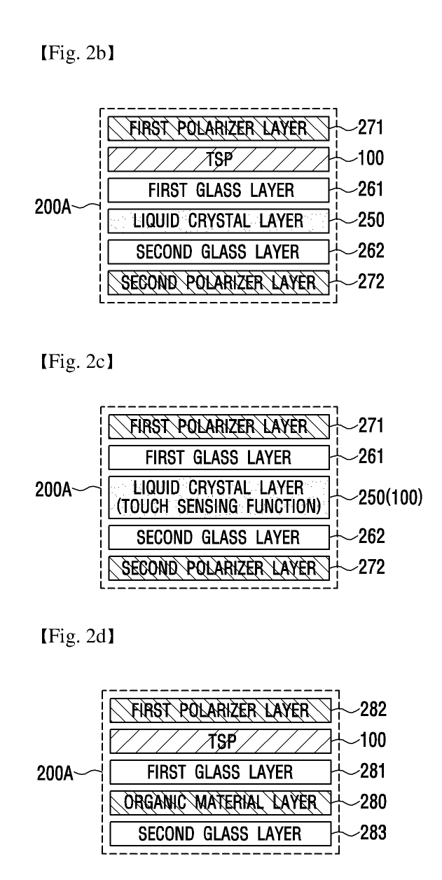

FIGS. 2a to 2e are conceptual views illustratively showing a relative position of the touch sensor panel 100 with respect to the display panel 200A in the touch input device according to the embodiment of the present invention. First, the relative position of the touch sensor panel 100 with respect to the display panel 200A using the LCD panel will be described with reference to FIGS. 2a to 2c.

As shown in FIGS. 2a to 2c, the LCD panel may include a liquid crystal layer 250 including a liquid crystal cell, a first glass layer 261 and a second glass layer 262 which are disposed on both sides of the liquid crystal layer 250 and include electrodes, a first polarizer layer 271 formed on a side of the first glass layer 261 in a direction facing the liquid crystal layer 250, and a second polarizer layer 272 formed on a side of the second glass layer 262 in the direction facing the liquid crystal layer 250. Here, the first glass layer 261 may be color filter glass, and the second glass layer 262 may be TFT glass.

It is clear to those skilled in the art that the LCD panel may further include other configurations for the purpose of performing the displaying function and may be transformed.

FIG. 2a shows that the touch sensor panel 100 of the touch input device 1000 is disposed outside the display panel 200A. The touch surface of the touch input device 1000 may be the surface of the touch sensor panel 100. In FIG. 2a, the top surface of the touch sensor panel 100 is able to function as the touch surface. Also, according to the embodiment, the touch surface of the touch input device 1000 may be the outer surface of the display panel 200A. In FIG. 2a, the bottom surface of the second polarizer layer 272 of the display panel 200A is able to function as the touch surface. Here, in order to protect the display panel 200A, the bottom surface of the display panel 200A may be covered with a cover layer (not shown) like glass.

FIGS. 2b and 2c show that the touch sensor panel 100 of the touch input device 1000 is disposed inside the display panel 200A. Here, in FIG. 2b, the touch sensor panel 100 for detecting the touch position is disposed between the first glass layer 261 and the first polarizer layer 271. Here, the touch surface of the touch input device 1000 is the outer surface of the display panel 200A. The top surface or bottom surface of the display panel 200A in FIG. 2b may be the touch surface. FIG. 2c shows that the touch sensor panel 100 for detecting the touch position is included in the liquid crystal layer 250. Here, the touch surface of the touch input device 1000 is the outer surface of the display panel 200A. The top surface or bottom surface of the display panel 200A in FIG. 2c may be the touch surface. In FIGS. 2b and 2c, the top surface or bottom surface of the display panel 200A, which can be the touch surface, may be covered with a cover layer (not shown) like glass.

Next, a relative position of the touch sensor panel 100 with respect to the display panel 200A using an OLED panel will be described with reference to FIGS. 2d and 2e. In FIG. 2d, the touch sensor panel 100 is positioned between a polarizer layer 282 and a first glass layer 281. In FIG. 2e, the touch sensor panel 100 is positioned between an organic material layer 280 and a second glass layer 283.

Here, the first glass layer 281 may be made of encapsulation glass. The second glass layer 283 may be made of TFT glass. Since the touch sensing has been described above, the other configurations only will be briefly described.

The OLED panel is a self-light emitting display panel which uses a principle where, when current flows through a fluorescent or phosphorescent organic thin film and then electrons and electron holes are combined in the organic material layer, so that light is generated. The organic matter constituting the light emitting layer determines the color of the light.

Specifically, the OLED uses a principle in which when electricity flows and an organic matter is applied on glass or plastic, the organic matter emits light. That is, the principle is that electron holes and electrons are injected into the anode and cathode of the organic matter respectively and are recombined in the light emitting layer, so that a high energy exciton is generated and the exciton releases the energy while falling down to a low energy state and then light with a particular wavelength is generated. Here, the color of the light is changed according to the organic matter of the light emitting layer.

The OLED includes a line-driven passive-matrix organic light-emitting diode (PM-OLED) and an individual driven active-matrix organic light-emitting diode (AM-OLED) in accordance with the operating characteristics of a pixel constituting a pixel matrix. None of them require a backlight. Therefore, the OLED enables a very thin display module to be implemented, has a constant contrast ratio according to an angle and obtains a good color reproductivity depending on a temperature. Also, it is very economical in that non-driven pixel does not consume power.

In terms of operation, the PM-OLED emits light only during a scanning time at a high current, and the AM-OLED maintains a light emitting state only during a frame time at a low current. Therefore, the AM-OLED has a resolution higher than that of the PM-OLED and is advantageous for driving a large area display panel and consumes low power. Also, a thin film transistor (TFT) is embedded in the AM-OLED, and thus, each component can be individually controlled, so that it is easy to implement a delicate screen.

As shown in FIGS. 2d and 2e, basically, the OLED (particularly, AM-OLED) panel includes the polarizer layer 282, the first glass layer 281, the organic layer 280, and the second glass layer 283. Here, the first glass layer 281 may be made of cover glass. The second glass layer 283 may be made of TFT glass. However, they are not limited to this.

Also, the organic layer 280 may include a hole injection layer (HIL), a hole transport layer (HTL), an electron injection layer (EIL), an electron transport layer (ETL), and an light-emitting layer (EML).

Briefly describing each of the layers, HIL injects electron holes and is made of a material such as CuPc, etc. HTL functions to move the injected electron holes and mainly is made of a material having a good hole mobility. Arylamine, TPD, and the like may be used as the HTL. The EIL and ETL inject and transport electrons. The injected electrons and electron holes are combined in the EML and emit light. The EML represents the color of the emitted light and is composed of a host determining the lifespan of the organic matter and an impurity (dopant) determining the color sense and efficiency. This just describes the basic structure of the organic layer 280 include in the OLED panel. The present invention is not limited to the layer structure or material, etc., of the organic layer 280.

The organic layer 280 is inserted between an anode (not shown) and a cathode (not shown). When the TFT becomes an on-state, a driving current is applied to the anode and the electron holes are injected, and the electrons are injected to the cathode. Then, the electron holes and electrons move to the organic layer 280 and emit the light.

Also, according to the embodiment of the present invention, at least a portion of the touch sensor may be configured to be placed within the display panel 200A and at least a portion of the remaining touch sensor may be configured to be placed outside the display panel 200A. For example, one of the drive electrode TX and the receiving electrode RX, which constitute the touch sensor panel 100, may be configured to be placed outside the display panel 200A, and the other may be configured to be placed inside the display panel 200A. When the touch sensor is placed within the display panel 200, an electrode for operation of the touch sensor may be additionally disposed. However, various configurations and/or electrodes positioned inside the display panel 200A may be used as the touch sensor for sensing the touch.

The second glass layer 262 may be comprised of various layers including a data line, a gate line, TFT, a common electrode, and a pixel electrode, etc. These electrical components may generate a controlled electric field and operate in such a manner as to orient liquid crystals located in the liquid crystal layer 250. One of the data line, gate line, TFT, common electrode, and pixel electrode included in the second glass layer 262 may be used as the touch sensor.

Up to now, the touch position detection by the touch sensor panel 100 according to the embodiment of the present invention has been described. Additionally, through use of the touch sensor panel 100 according to the embodiment of the present invention, it is possible to detect the magnitude of the touch pressure as well as whether the touch has occurred or not and/or where the touch has occurred. Also, the touch input device to which the pressure detection module according to the embodiment of the present invention is applied may not include the touch sensor panel 100. Also, a pressure sensor for detecting the touch pressure is included separately from the touch sensor panel 100, so that it is possible to detect the magnitude of the touch pressure. Hereafter, the pressure sensor and the touch input device including the same will be described in detail.

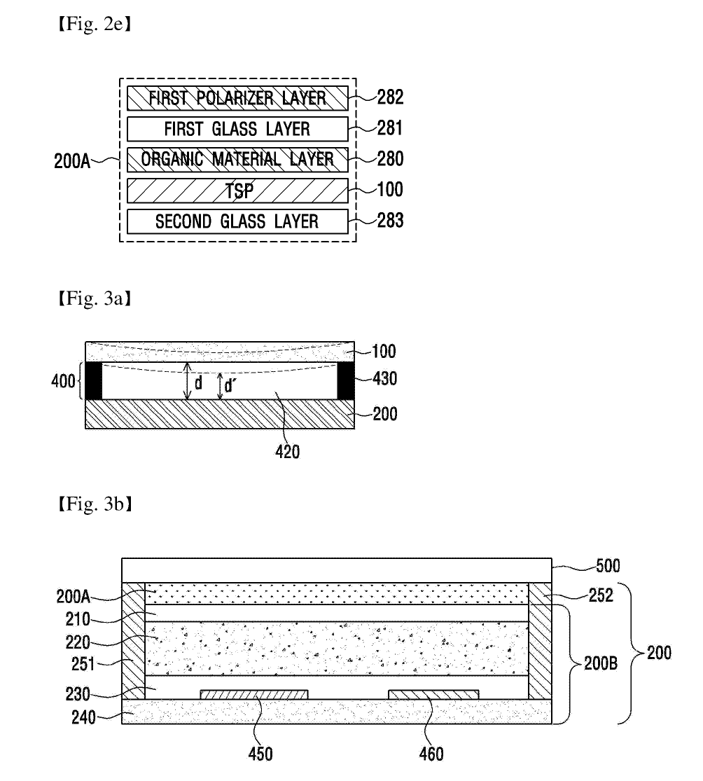

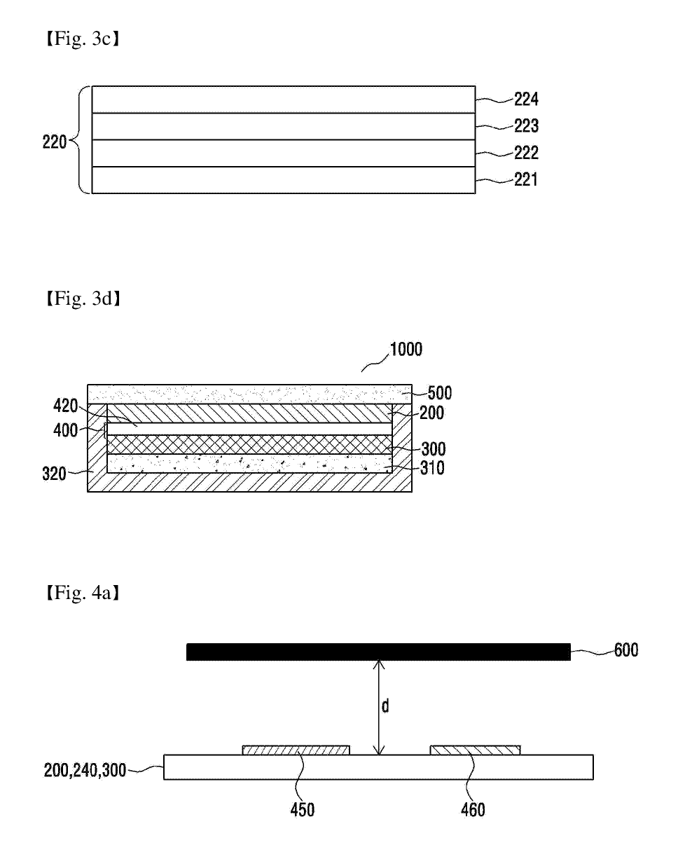

FIG. 3a is a cross sectional view showing a first example of the touch input device configured to detect a touch position and a touch pressure in accordance with the embodiment. In the touch input device 1000 including a display module 200, a pressure detection module 400 and the touch sensor panel 100 which detects the touch position may be attached to the front side of the display panel 200. Accordingly, it is possible to protect a display screen of the display panel 200 and to increase a touch detection sensitivity of the touch sensor panel 100.

Here, the pressure detection module 400 may operate separately from the touch sensor panel 100 which detects the touch position. For example, the pressure detection module 400 may detect only the pressure independently of the touch sensor panel 100 which detects the touch position. Also, the pressure detection module 400 may be configured to be coupled to the touch sensor panel 100 which detects the touch position and to detect the touch pressure. For example, at least one of the drive electrode TX and the receiving electrode RX included in the touch sensor panel 100 which detects the touch position may be used to detect the touch pressure.

FIG. 3a shows that the pressure detection module 400 is coupled to the touch sensor panel 100 and detects the touch pressure. In FIG. 3a, the pressure detection module 400 includes a spacer layer 420 which leaves a space between the touch sensor panel 100 and the display module 200. The pressure detection module 400 may include a reference potential layer spaced from the touch sensor panel 100 by the spacer layer 420. Here, the display module 200 may function as the reference potential layer.

The reference potential layer may have any potential which causes the change of the capacitance 101 generated between the drive electrode TX and the receiving electrode RX. For instance, the reference potential layer may be a ground layer having a ground potential. The reference potential layer may be the ground layer of the display module 200. Here, the reference potential layer may have a parallel plane with the two-dimensional plane of the touch sensor panel 100.

As shown in FIG. 3a, the touch sensor panel 100 is disposed apart from the display module 200, i.e., the reference potential layer. Here, depending on a method for adhering the touch sensor panel 100 to the display module 200, the spacer layer 420 may be implemented in the form of an air gap between the touch sensor panel 100 and the display module 200. The spacer layer 420 may be made of an impact absorbing material in accordance with the embodiment. Here, the impact absorbing material may include sponge and a graphite layer. The spacer layer 420 may be filled with a dielectric material in accordance with the embodiment. The spacer layer 420 may be formed through a combination of the air gap, the impact absorbing material, and the dielectric material.

Here, a double adhesive tape (DAT) 430 may be used to fix the touch sensor panel 100 and the display module 200. For example, the areas the touch sensor panel 100 and the display module 200 are overlapped with each other. The touch sensor panel 100 and the display module 200 are adhered to each other by adhering the edge portions of the touch sensor panel 100 and the display module 200 through use of the DAT 430. The rest portions of the touch sensor panel 100 and the display module 200 may be spaced apart from each other by a predetermined distance “d”.

In general, even when the touch surface is touched without bending the touch sensor panel 100, the capacitance (Cm) 101 between the drive electrode TX and the receiving electrode RX is changed. That is, when the touch occurs on the touch sensor panel 100, the mutual capacitance (Cm) 101 may become smaller than a base mutual capacitance. This is because, when the conductive object like a finger approaches close to the touch sensor panel 100, the object functions as the ground GND, and then a fringing capacitance of the mutual capacitance (Cm) 101 is absorbed in the object. The base mutual capacitance is the value of the mutual capacitance between the drive electrode TX and the receiving electrode RX when there is no touch on the touch sensor panel 100.

When the object touches the top surface, i.e., the touch surface of the touch sensor panel 100 and a pressure is applied to the top surface, the touch sensor panel 100 may be bent. Here, the value of the mutual capacitance (Cm) 101 between the drive electrode TX and the receiving electrode RX may be more reduced. This is because the bend of the touch sensor panel 100 causes the distance between the touch sensor panel 100 and the reference potential layer to be reduced from “d” to “d′”, so that the fringing capacitance of the mutual capacitance (Cm) 101 is absorbed in the reference potential layer as well as in the object. When a nonconductive object touches, the change of the mutual capacitance (Cm) 101 is simply caused by only the change of the distance “d-d′” between the touch sensor panel 100 and the reference potential layer.

As described above, the touch input device 1000 is configured to include the touch sensor panel 100 and the pressure detection module 400 on the display module 200, so that not only the touch position but also the touch pressure can be simultaneously detected.

However, as shown in FIG. 3a, when the pressure detection module 400 as well as the touch sensor panel 100 is disposed on the display module 200, the display properties of the display panel is deteriorated. Particularly, when the air gap is included on the display module 200, the visibility and optical transmittance of the display panel may be lowered.

Accordingly, in order to prevent such problems, the air gap is not disposed between the display module 200 and the touch sensor panel 100 for detecting the touch position. Instead, the touch sensor panel 100 and the display module 200 can be fully laminated by means of an adhesive like an optically clear adhesive (OCA).

Although the following FIGS. 3b and 3d do not show the touch sensor panel 100 separately, the touch sensor panel 100 of the touch input device 1000 according to the embodiment may be located outside or inside the display module 200.

FIG. 3b is a cross sectional view showing a second example of the touch input device configured to detect the touch position and the touch pressure in accordance with the embodiment. The cross sectional view of the touch input device 1000 shown in FIG. 3b may be a cross sectional view of a portion of the touch input device 1000. As shown in FIG. 3b, the touch input device 1000 according to the embodiment of the present invention may include the display panel 200A, a backlight unit 200B disposed under the display panel 200A, and a cover layer 500 disposed on the display panel 200A. In the touch input device 1000 according to the embodiment, the pressure sensor 450 and 460 may be formed on a cover 240. In this specification, the display panel 200A and the backlight unit 200B are collectively referred to as the display module 200. FIG. 3b shows that the pressure sensor 450 and 460 is attached on the cover 240. However, according to the embodiment, the pressure sensor 450 and 460 can be also attached to a configuration which is included in the touch input device 1000 and performs the same or similar function as/to that of the cover 240.

The touch input device 1000 according to the embodiment may include an electronic device including a touch screen, for example, a cell phone, a personal data assistant (PDA), a smart phone, a tablet personal computer, an MP3 player, a laptop computer, etc.

At least a portion of the touch sensor is included within the display panel 200A in the touch input device 1000 according to the embodiment. Also, according to the embodiment, the drive electrode and the receiving electrode which are for sensing the touch may be included within the display panel 200A.

The cover layer 500 according to the embodiment may be comprised of a cover glass which protects the front side of the display panel 200A and forms the touch surface. As shown in FIG. 3b, the cover layer 500 may be formed wider than the display panel 200A.

Since the display panel 200A such as the LCD panel according to the embodiment performs a function of only blocking or transmitting the light without emitting light by itself, the backlight unit 200B may be required. For example, the backlight unit 200B is disposed under the display panel 200A, includes a light source and throws the light on the display panel 200A, so that not only brightness and darkness but also information having a variety of colors is displayed on the screen. Since the display panel 200A is a passive device, it is not self-luminous. Therefore, the rear side of the display panel 200A requires a light source having a uniform luminance distribution.

The backlight unit 200B according to the embodiment may include an optical layer 220 for illuminating the display panel 200A. The optical layer 220 will be described in detail with reference to FIG. 3c.

The backlight unit 200B according to the embodiment may include the cover 240. The cover 240 may be made of a metallic material. When a pressure is applied from the outside through the cover layer 500 of the touch input device 1000, the cover layer 500, the display module 200, etc., may be bent. Here, the bending causes a distance between the pressure sensor 450 and 460 and a reference potential layer located within the display module to be changed. The capacitance change caused by the distance change is detected through the pressure sensor 450 and 460, so that the magnitude of the pressure can be detected. Here, a pressure is applied to the cover layer 500 in order to precisely detect the magnitude of the pressure, the position of the pressure sensor 450 and 460 needs to be fixed without changing. Therefore, the cover 240 is able to perform a function of a support capable of fixing a pressure sensor without being bent even by the application of pressure. According to the embodiment, the cover 240 is manufactured separately from the backlight unit 200B, and may be assembled together when the display module is manufactured.

In the touch input device 1000 according to the embodiment, a first air gap 210 may be included between the display panel 200A and the backlight unit 200B. This intends to protect the display panel 200A and/or the backlight unit 200B from an external impact. This first air gap 210 may be included in the backlight unit 200B.

The optical layer 220 and the cover 240, which are included in the backlight unit 200B, may be configured to be spaced apart from each other. A second air gap 230 may be provided between the optical layer 220 and the cover 240. The second air gap 230 may be required in order to ensure that the pressure sensor 450 and 460 disposed on the cover 240 does not contact with the optical layer 220, and in order to prevent that the optical layer 220 contacts with the pressure sensor 450 and 460 and deteriorates the performance of the optical layer 220 even though an external pressure is applied to the cover layer 500 and the optical layer 220, the display panel 200A, and the cover layer 500 are bent.

The touch input device 1000 according to the embodiment may further include a support 251 and 252 such that the display panel 200A, the backlight unit 200B, and the cover layer 500 are coupled to maintain a fixed shape. According to the embodiment, the cover 240 may be integrally formed with the support 251 and 252. According to the embodiment, the support 251 and 252 may form a portion of the backlight unit 200B.

The structure and function of the LCD panel 200A and the backlight unit 200B is a publicly known art and will be briefly described below. The backlight unit 200B may include several optical parts.

FIG. 3c shows the optical layer 220 of the backlight unit 200B in the touch input device according to the embodiment. FIG. 3c shows the optical layer 220 when the LCD panel is used as the display panel 200A.

In FIG. 3c, the optical layer 220 of the backlight unit 200B may include a reflective sheet 221, a light guide plate 222, a diffuser sheet 223, and a prism sheet 224. Here, the backlight unit 200B may include a light source (not shown) which is formed in the form of a linear light source or point light source and is disposed on the rear and/or side of the light guide plate 222.

The light guide plate 222 may generally convert lights from the light source (not shown) in the form of a linear light source or point light source into light from a light source in the form of a surface light source, and allow the light to proceed to the LCD panel 200A.

A part of the light emitted from the light guide plate 222 may be emitted to a side opposite to the LCD panel 200A and be lost. The reflective sheet 221 may be positioned below the light guide plate 222 so as to cause the lost light to be incident again on the light guide plate 222, and may be made of a material having a high reflectance.

The diffuser sheet 223 functions to diffuse the light incident from the light guide plate 222. For example, light scattered by the pattern of the light guide plate 222 comes directly into the eyes of the user, and thus, the pattern of the light guide plate 222 may be shown as it is. Moreover, since such a pattern can be clearly sensed even after the LCD panel 200A is mounted, the diffuser sheet 223 is able to perform a function to offset the pattern of the light guide plate 222.

After the light passes through the diffuser sheet 223, the luminance of the light is rapidly reduced. Therefore, the prism sheet 224 may be included in order to improve the luminance of the light by focusing the light again. The prism sheet 224 may include, for example, a horizontal prism sheet and a vertical prism sheet.

The backlight unit 200B according to the embodiment may include a configuration different from the above-described configuration in accordance with the technical change and development and/or the embodiment. The backlight unit 200B may further include an additional configuration as well as the foregoing configuration. Also, in order to protect the optical configuration of the backlight unit 200B from external impacts and contamination, etc., due to the introduction of the alien substance, the backlight unit 200B according to the embodiment may further include, for example, a protection sheet on the prism sheet 224. The backlight unit 200B may also further include a lamp cover in accordance with the embodiment so as to minimize the optical loss of the light source. The backlight unit 200B may also further include a frame which maintains a shape enabling the light guide plate 222, the diffuser sheet 223, the prism sheet 224, a lamp (not shown), and the like, which are main components of the backlight unit 200B, to be exactly combined together in accordance with an allowed dimension. Also, the each of the configurations may be comprised of at least two separate parts.

According to the embodiment, an additional air gap may be positioned between the light guide plate 222 and the reflective sheet 221. As a result, the lost light from the light guide plate 222 to the reflective sheet 221 can be incident again on the light guide plate 222 by the reflective sheet 221. Here, between the light guide plate 222 and the reflective sheet 221, for the purpose of maintaining the additional air gap, the double adhesive tape (DAT) may be included on the edges of the light guide plate 222 and the reflective sheet 221.

As described above, the backlight unit 200B and the display module including the backlight unit 200B may be configured to include in itself the air gap such as the first air gap 210 and/or the second air gap 230. Also, the air gap may be included between a plurality of the layers included in the optical layer 220. Although the foregoing has described that the LCD panel 200A is used, the air gap may be included within the structure of another display panel.

FIG. 3d is a cross sectional view showing a third example of the touch input device configured to detect the touch position and the touch pressure in accordance with the embodiment. FIG. 3d shows a cross section of the touch input device 1000 that further includes a substrate 300 as well as the display module 200. In the touch input device 1000 according to the embodiment, the substrate 300, together with a second outermost cover 320 of the touch input device 1000, functions as, for example, a housing which surrounds a mounting space 310, etc., where the circuit board and/or battery for operation of the touch input device 1000 are located. Here, the circuit board for operation of the touch input device 1000 may be a main board. A central processing unit (CPU), an application processor (AP) or the like may be mounted on the circuit board. Due to the substrate 300, the display module 200 is separated from the circuit board and/or battery for operation of the touch input device 1000. Due to the substrate 300, electrical noise generated from the display module 200 can be blocked. According to the embodiment, the substrate 300 may be referred to as a mid-frame in the touch input device 1000.

In the touch input device 1000, the cover layer 500 may be formed wider than the display module 200, the substrate 300, and the mounting space 310. As a result, the second cover 320 is formed in such a manner as to surround the display module 200, the substrate 300, and the mounting space 310 where the circuit board is located.

The touch input device 1000 according to the embodiment may detect the touch position through the touch sensor panel 100 and include the pressure detection module 400 between the display module 200 and the substrate 300.

Here, the pressure sensor included in the pressure detection module 400 may be formed on the substrate 300, may be formed on the display module 200, or may be formed on the display module 200 and the substrate 300. Also, the electrode 450 and 460 constituting the pressure sensor included in the pressure detection module 400 may be included in the touch input device 1000 in the form of an electrode sheet 440 including the corresponding electrode. This will be described below in detail.

As shown in FIGS. 3b and 3d, since the pressure detection module 400 in the touch input device 1000 is disposed between the display module 200 and the substrate 300 and under the display module 200, the electrode constituting the pressure sensor included in the pressure detection module 400 can be made of not only a transparent material but also an opaque material.

Hereafter, in the touch input device 1000 according to the embodiment of the present invention, the principle and structure for detecting the magnitude of touch pressure by using the pressure sensor 450 and 460 will be described in detail.

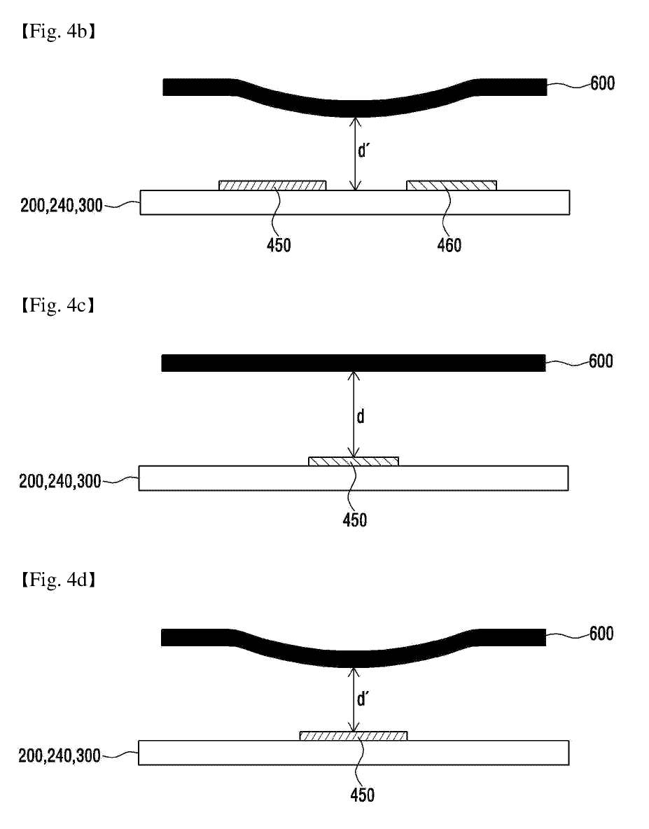

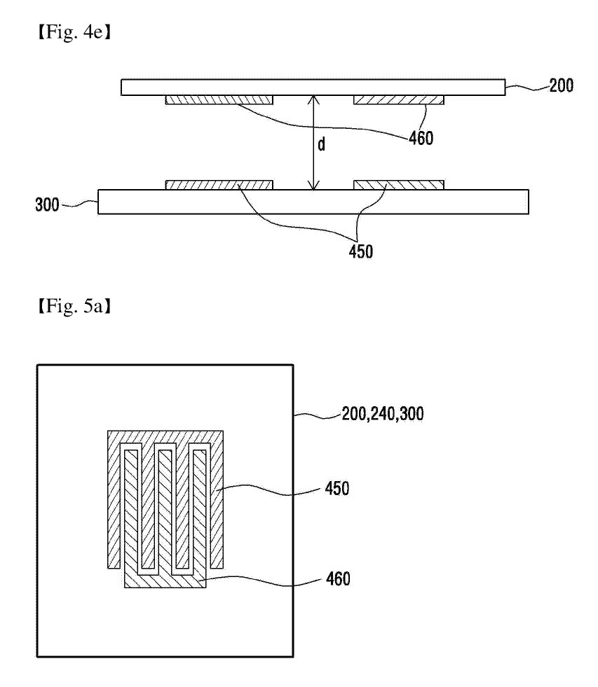

FIGS. 4a and 4b show a relative distance between a reference potential layer and a pressure sensor of the first example which are included in the touch input device, and show a pressure is applied to the touch input device.

In the touch input device 1000 according to the embodiment of the present invention, the pressure sensor 450 and 460 may be attached on the cover 240 capable of constituting the backlight unit 200B. In the touch input device 1000, the pressure sensor 450 and 460 and the reference potential layer 600 may be spaced apart from each other by a distance “d”.

In FIG. 4a, the reference potential layer 600 and the pressure sensor 450 and 460 may be spaced apart from each other with a spacer layer (not shown) placed therebetween. Here, as described with reference to FIGS. 3b and 3c, the spacer layer may be the first air gap 210, the second air gap 230, and/or an additional air gap which are included in the manufacture of the display module 200 and/or the backlight unit 200B. When the display module 200 and/or the backlight unit 200B includes one air gap, the one air gap is able to perform the function of the spacer layer. When the display module 200 and/or the backlight unit 200B includes a plurality of air gaps, the plurality of air gaps are able to collectively perform the function of the spacer layer.

In the touch input device 1000 according to the embodiment, the spacer layer may be located between the reference potential layer 600 and the pressure sensor 450 and 460. As a result, when a pressure is applied to the cover layer 500, the reference potential layer 600 is bent, so that a relative distance between the reference potential layer 600 and the pressure sensor 450 and 460 may be reduced.

In the touch input device 1000 according to the embodiment, the display module 200 may be bent or pressed by the touch applying the pressure. The display module may be bent or pressed in such a manner as to show the biggest transformation at the touch position. When the display module is bent or pressed according to the embodiment, a position showing the biggest transformation may not match the touch position. However, the display module may be shown to be bent or pressed at least at the touch position. For example, when the touch position approaches close to the border, edge, etc., of the display module, the most bent or pressed position of the display module may not match the touch position, however, the display module may be shown to be bent or pressed at least at the touch position.

When the cover layer 500, the display panel 200A, and/or the back light unit 200B are bent or pressed at the time of touching the touch input device 1000 according to the embodiment, the cover 240 positioned below the spacer layer, as shown in FIG. 4b, may be less bent or pressed due to the spacer layer. While FIG. 4b shows that the cover 240 is not bent or pressed at all, this is just an example. The lowest portion of the cover 240 to which the pressure sensor 450 and 460 has been attached may be bent or pressed. However, the degree to which the lowest portion of the cover 240 is bent or pressed can be reduced by the spacer layer.

According to the embodiment, the spacer layer may be implemented in the form of the air gap. The spacer layer may be made of an impact absorbing material in accordance with the embodiment. The spacer layer may be filled with a dielectric material in accordance with the embodiment.

FIG. 4b shows that a pressure is applied to the structure of FIG. 4a. For example, when the external pressure is applied to the cover layer 500 shown in FIG. 3b, it can be seen that a relative distance between the reference potential layer 600 and the pressure sensor 450 and 460 is reduced from “d” to “d′”. Accordingly, in the touch input device 1000 according to the embodiment, when the external pressure is applied, the reference potential layer 600 is configured to be more bent than the cover 240 to which the pressure sensor 450 and 460 has been attached, so that it is possible to detect the magnitude of touch pressure.

FIGS. 3b, 4a, and 4b show that a first electrode 450 and a second electrode 460 are included as the pressure sensor 450 and 460 for detecting the pressure. Here, the mutual capacitance may be generated between the first electrode 450 and the second electrode 460. Here, any one of the first and the second electrodes 450 and 460 may be a drive electrode and the other may be a receiving electrode. A driving signal is applied to the drive electrode, and a sensing signal may be obtained through the receiving electrode. When voltage is applied, the mutual capacitance may be generated between the first electrode 450 and the second electrode 460.

The reference potential layer 600 have any potential which causes the change of the mutual capacitance generated between the first electrode 450 and the second electrode 460. For instance, the reference potential layer 600 may be a ground layer having a ground potential. The reference potential layer 600 may be any ground layer which is included in the display module. According to the embodiment, the reference potential layer 600 may be a ground potential layer which is included in itself during the manufacture of the touch input device 1000. For example, in the display panel 200 shown in FIGS. 2a to 2c, an electrode (not shown) for blocking noise may be included between the first polarizer layer 271 and the first glass layer 261. This electrode for blocking the noise may be composed of ITO and may function as the ground. Also, according to the embodiment, a plurality of the common electrodes included in the display panel 200 constitutes the reference potential layer 600. Here, the potential of the common electrode may be a reference potential.

When a pressure is applied to the cover layer 500 by means of an object, at least a portion of the display panel 200A and/or the backlight unit 200B is bent, so that a relative distance between the reference potential layer 600 and the first and second electrodes 450 and 460 may be reduced from “d” to “d′”. Here, the less the distance between the reference potential layer 600 and the first and second electrodes 450 and 460 is, the less the value of the mutual capacitance between the first electrode 450 and the second electrode 460 may be. This is because the distance between the reference potential layer 600 and the first and second electrodes 450 and 460 is reduced from “d” to “d′”, so that a fringing capacitance of the mutual capacitance is absorbed in the reference potential layer 600 as well as in the object. When a nonconductive object touches, the change of the mutual capacitance is simply caused by only the change of the distance “d-d′” between the reference potential layer 600 and the electrodes 450 and 460.

The foregoing has described that the first electrode 450 and the second electrode 460 are included as the pressure sensor 450 and 460, and the pressure is detected by the change of the mutual capacitance between the first electrode 450 and the second electrode 460. The pressure sensor 450 and 460 may be configured to include only any one of the first electrode 450 and the second electrode 460 (for example, the first electrode 450).

FIGS. 4c and 4d show a relative distance between a reference potential layer and a pressure sensor of the second example which are included in the touch input device, and show that a pressure is applied to the touch input device. Here, it is possible to detect the magnitude of touch pressure by detecting the self-capacitance between the first electrode 450 and the reference potential layer 600. Here, the change of the self-capacitance between the first electrode 450 and the reference potential layer 600 is detected by applying the driving signal to the first electrode 450 and by receiving the reception signal from the first electrode 450, so that the magnitude of the touch pressure is detected.

For example, the magnitude of the touch pressure can be detected by the change of the capacitance between the first electrode 450 and the reference potential layer 600, which is caused by the distance change between the reference potential layer 600 and the first electrode 450. Since the distance “d” is reduced with the increase of the touch pressure, the capacitance between the reference potential layer 600 and the first electrode 450 may be increased with the increase of the touch pressure.

According to the embodiment, when the magnitude of the touch pressure is sufficiently large, a state may be created in which the distance between the reference potential layer 600 and the pressure sensors 450 and 460 is not reduced any more at a predetermined position. Hereafter, this state will be referred to as a saturation state. However, even in this case, when the magnitude of the touch pressure becomes larger, an area in the saturation state where the distance between the reference potential layer 600 and the pressure sensors 450 and 460 is not reduced any more may become greater. The greater the area is, the more the mutual capacitance between the first electrode 450 and the second electrode 460 may be reduced. Hereafter, it will be described that the magnitude of the touch pressure is calculated by the change of the capacitance according to the distance change. However, this may include that the magnitude of the touch pressure is calculated by the change of the area in the saturation state. This may be applied to embodiments related to FIG. 4e.

FIGS. 3b and 4a to 4d show that the first electrode 450 and/or the second electrode 460 are relatively thick and they are directly attached to the cover 240. However, this is just only for convenience of description. In accordance with the embodiment, the first electrode 450 and/or the second electrode 460 may be, for example, attached to the cover 240 in the form of a sheet and may have a relatively small thickness.

Although the foregoing has described that the pressure sensor 450 and 460 is attached to the cover 240 by referencing the touch input device 1000 shown in FIG. 3b, the pressure sensor 450 and 460 may be disposed between the display module 200 and the substrate 300 in the touch input device 1000 shown in FIG. 3c. According to the embodiment, the pressure sensor 450 and 460 may be disposed under the display module 200. In this case, the reference potential layer 600 may be any potential layer which is disposed within the substrate 300 or the display module 200. Also, according to the embodiment, the pressure sensor 450 and 460 may be attached to the substrate 300. In this case, the reference potential layer 600 may be any potential layer which is disposed on or within the display module 200.

FIG. 4e shows the arrangement of pressure sensors of the third example which is included in the touch input device. As shown in FIG. 4e, the first electrode 450 out of the pressure sensor 450 and 460 may be disposed on the substrate 300, and the second electrode 460 may be disposed under the display module 200. In this case, a separate reference potential layer may not be required. When a pressure touch is performed on the touch input device 1000, a distance between the display module 200 and the substrate 300 may be changed, and thus, the mutual capacitance between the first electrode 450 and the second electrode 460 may be increased. Through the capacitance change, the magnitude of the touch pressure can be detected.

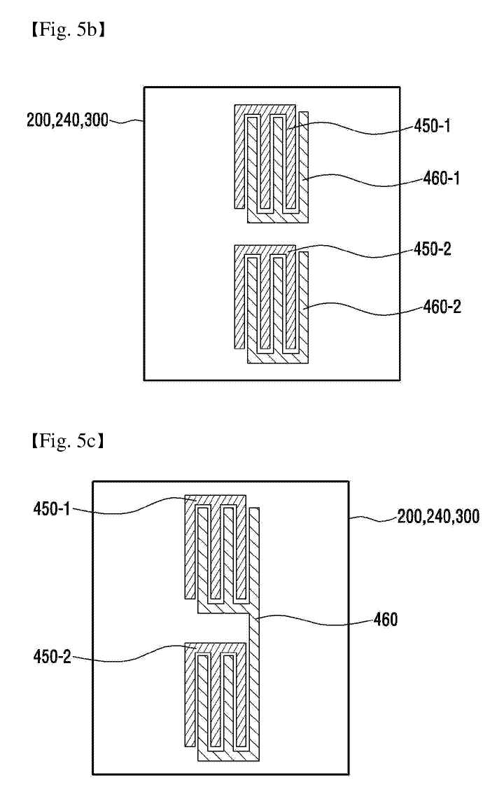

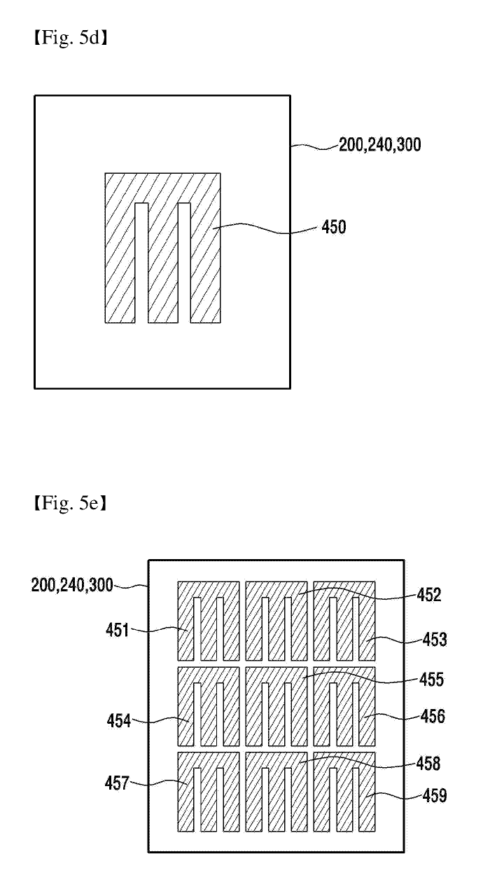

FIGS. 5a to 5e show patterns according to the first to the fifth examples of an electrode constituting the pressure sensor according to the embodiment.

FIG. 5a shows that a pattern according to the first example of a pressure electrode when the touch pressure is detected through the change of the mutual capacitance between the first electrode 450 and the second electrode 460. When the magnitude of the touch pressure is detected as the mutual capacitance between the first electrode 450 and the second electrode 460 is changed, it is necessary to form the patterns of the first electrode 450 and the second electrode 460 so as to generate the range of the capacitance required to improve the detection accuracy. With the increase of a facing area or facing length of the first electrode 450 and the second electrode 460, the size of the capacitance that is generated may become larger. Therefore, the pattern can be designed by adjusting the size of the facing area, facing length and facing shape of the first electrode 450 and the second electrode 460 in accordance with the range of the necessary capacitance. FIG. 5a shows a pressure electrode pattern having a comb teeth shape such that the facing length of the first electrode 450 and the second electrode 460 becomes longer.

FIG. 5a shows that the first electrode 450 and the second electrode 460 constitutes one channel for detecting the pressure. FIG. 5b shows a pattern when the pressure sensor constitutes two channels. FIG. 5b shows a first electrode 450-1 and a second electrode 460-1 which constitute a first channel, and a first electrode 450-2 and a second electrode 460-2 which constitute a second channel. FIG. 5c shows that the first electrode 450 constitutes two channels 450-1 and 450-2, and the second electrode 460 constitutes one channel Since the pressure sensor detects the magnitude of the touch pressure at different positions through the first channel and the second channel, even when a multi touch occurs, the magnitude of each touch pressure can be detected. Here, in accordance with the embodiment, the pressure sensor 450 and 460 may be configured to constitute a larger number of channels.

FIG. 5d shows an electrode pattern when the size of the touch pressure is detected according to the change of the self-capacitance between the reference potential layer 600 and the first electrode 450. Although FIG. 5d shows a pattern having a comb teeth shape as the first electrode 450, the first electrode 450 may have a plate shape (for example, a quadrangular plate shape).

FIG. 5e shows that each of the first electrode 451 to 459 constitutes nine channels. That is, FIG. 5d shows that one channel is constituted, and FIG. 5e shows a pressure sensor when nine channels are constituted. Therefore, in FIG. 5e, even when a multi touch occurs, the size of each touch pressure can be detected. Here, the pressure sensor can be configured to constitute another number of the channels.

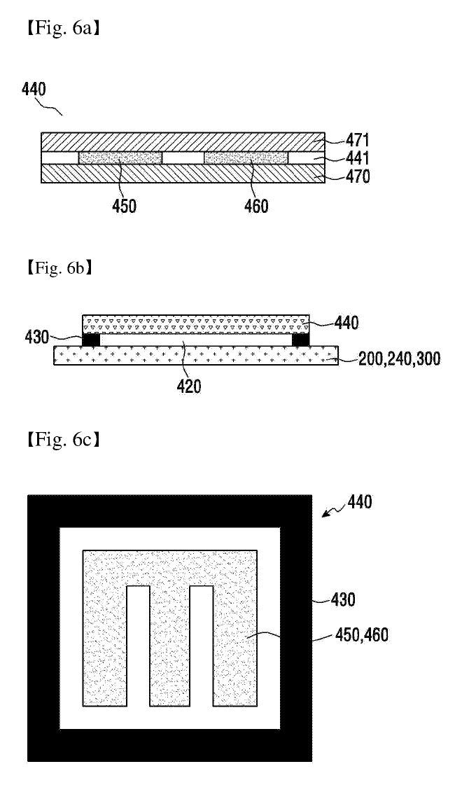

FIG. 6a is a cross sectional view of an exemplary electrode sheet including the pressure electrode for being attached to the touch input device according to the embodiment of the present invention. For example, the electrode sheet 440 may include an electrode layer 441 between a first insulation layer 470 and a second insulation layer 471. The electrode layer 441 may include the first electrode 450 and/or the second electrode 460. Here, the first insulation layer 470 and the second insulation layer 471 may be made of an insulating material like polyimide, Polyethylene Terephthalate (PET), etc. The first electrode 450 and the second electrode 460 included in the electrode layer 441 may include a material like copper, aluminum (Al), silver (Ag), etc. According to the manufacturing process of the electrode sheet 440, the electrode layer 441 and the second insulation layer 471 may be bonded to each other by an adhesive (not shown) like an optically clear adhesive (OCA). Also, according to the embodiment, the pressure electrodes 450 and 460 may be formed by positioning a mask, which has a through-hole corresponding to a pressure electrode pattern, on the first insulation layer 470, and then by spraying a conductive material or by printing the conductive material, or by applying a metallic material and etching. In FIG. 6 and the following description, it is shown that the electrode sheet 440 has a structure including the pressure electrodes 450 and 460 between the insulation layers 470 and 471, this is just an example. The electrode sheet 440 may simply include only the pressure electrodes 450 and 460.

In order that the touch pressure is detected in the touch input device 1000 according to the embodiment, the electrode sheet 440 may be attached to the substrate 300, the display module 200, or the cover 240 in such a manner as to be spaced apart from the substrate 300, the display module 200, or the cover 240, with the spacer layer 420 placed therebetween.

FIG. 6b is a cross sectional view of a portion of the touch input device to which the electrode sheet has been attached according to a first method. FIG. 6b shows that the electrode sheet 440 has been attached on the substrate 300, the display module 200, or the cover 240.

As shown in FIG. 6c, the adhesive tape 430 having a predetermined thickness may be formed along the border of the electrode sheet 440 so as to maintain the spacer layer 420. Though FIG. 6c shows that the adhesive tape 430 is formed along the entire border (for example, four sides of a quadrangle) of the electrode sheet 440, the adhesive tape 430 may be formed only on at least a portion (for example, three sides of a quadrangle) of the border of the electrode sheet 440. Here, as shown in FIG. 6c, the adhesive tape 430 may not be formed on an area including the pressure electrodes 450 and 460. As a result, when the electrode sheet 440 is attached to the substrate 300 or the display module 200 through the adhesive tape 430, the pressure electrodes 450 and 460 may be spaced apart from the substrate 300 or the display module 200 at a predetermined distance. According to the embodiment, the adhesive tape 430 may be formed on the top surface of the substrate 300, the bottom surface of the display module 200, the surface of the cover 240. Also, the adhesive tape 430 may be a double adhesive tape. FIG. 6c shows only one of the pressure electrodes 450 and 460. According to the embodiment, the electrode forming a plurality of channels may be included in one electrode sheet 440.

FIG. 6d is a partial cross sectional view of the touch input device to which the electrode sheet has been attached according to a second method. In FIG. 6d, after the electrode sheet 440 is placed on the substrate 300, the display module 200, or the cover 240, the electrode sheet 440 may be fixed to the substrate 300, the display module 200, or the cover 240 by means of the adhesive tape 430. For this, the adhesive tape 430 may come in contact with at least a portion of the electrode sheet 440 and at least a portion of the substrate 300, the display module 200, or the cover 240. FIG. 6d shows that the adhesive tape 430 continues from the top of the electrode sheet 440 to the exposed surface of the substrate 300, the display module 200, or the cover 240. Here, only a portion of the adhesive tape 430, which contacts with the electrode sheet 440, may have adhesive strength. Therefore, in FIG. 6d, the top surface of the adhesive tape 430 may not have the adhesive strength.

As shown in FIG. 6d, even if the electrode sheet 440 is fixed to the substrate 300, the display module 200, or the cover 240 by using the adhesive tape 430, a predetermined space, i.e., air gap may be created between the electrode sheet 440 and the substrate 300, the display module 200, or the cover 240. This is because the substrate 300, the display module 200, or the cover 240 is not directly attached to the electrode sheet 440 by means of the adhesive and because the electrode sheet 440 includes the pressure electrodes 450 and 460 having a pattern, so that the surface of the electrode sheet 440 may not be flat. The air gap of FIG. 6d may also function as the spacer layer 420 for detecting the touch pressure.

The foregoing has described the touch input device to which the pressure sensor and the pressure detection module according to the embodiment of the present invention are applied. Hereinafter, a pressure detection accuracy correction method through the pressure detection module according to the embodiment of the present invention and a pressure detector for the same will be described in detail. In the designs of the touch input device 1000 and the pressure detection module 400 for the same, the distance between the reference potential layer 600 and the pressure sensor 450 and 460 and/or a distance between the first electrode 450 and the second electrode 460 are determined. As a result, the magnitude of the pressure can be detected based on the change of the distance through the pressure detection module 400. However, the distance between the reference potential layer 600 and the pressure sensors 450 and 460 may be changed differently from an originally intended distance during the manufacturing, processing, use, etc., of the touch input device 1000. The distance between the reference potential layer 600 and the pressure sensors 450 and 460 may change only partially. Additionally, according to the embodiment, the change amount of the capacitance occurring between the reference potential layer 600 and the pressure sensors 450 and 460 may be different from that of an initial design. In this case, correction is required to maintain the pressure detection accuracy through the pressure detection module 400. Hereinafter, the pressure detection accuracy correction method will be described.

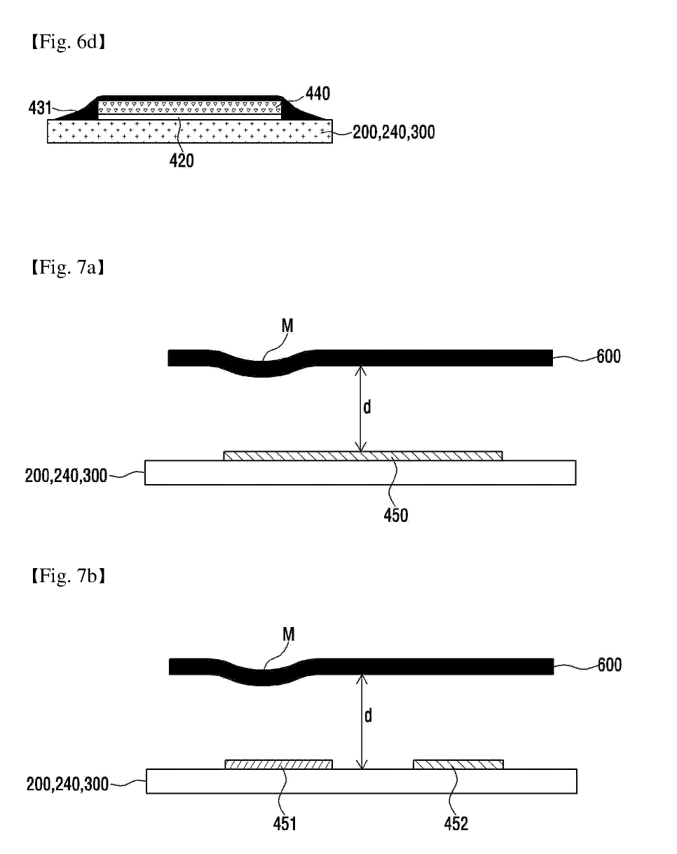

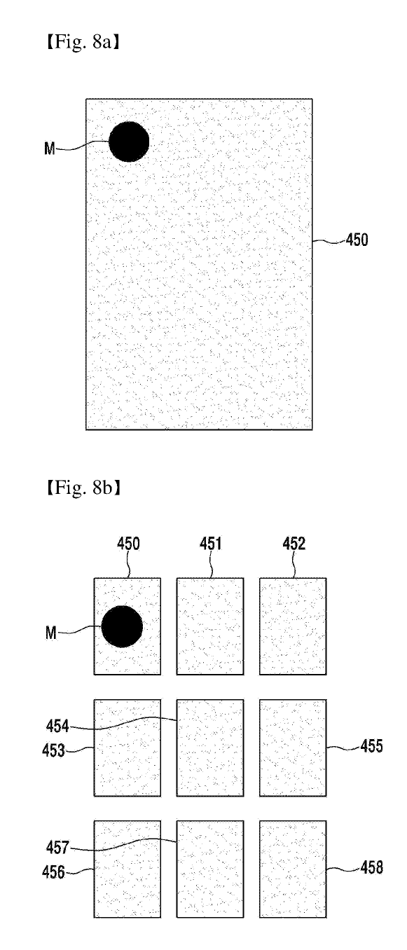

FIG. 7a shows a cross section of a portion of the touch input device to which the pressure sensor of which the pressure detection accuracy can be corrected according to a first embodiment has been attached. The description related to FIGS. 7a and 7b shows that only one electrode 450 detecting the self-capacitance is included as the pressure sensor, and the description can be also applied to a case where the first electrode 450 and the second electrode 460 detecting the mutual capacitance are included as a pressure sensor. FIG. 7a shows that the pressure sensor 450 is attached to the substrate 300, the display module 200 and/or the cover 240, and the reference potential layer 600 is spaced from this. For example, when the pressure sensor 450 is attached to the cover 240, the reference potential layer 600 may be any potential layer within the display module 200 or may be the substrate 300. When the pressure sensor 450 is attached to the bottom surface of the display module 200, the reference potential layer 600 may be any potential layer within the display module 200 or may be the substrate 300. When the pressure sensor 450 is attached to the top surface of the substrate 300, the reference potential layer 600 may be any potential layer within the display module 200 or may be the display module 200. Although not shown in FIG. 7a and in the following figures, the reference potential layer 600 may be the substrate 300 to which the pressure sensor 450 has been attached, the display module 200, or the cover 240.

FIG. 7a shows that a portion of the reference potential layer 600 has been deformed (denoted by M). This deformation M may be caused by mechanical deformation of the substrate 300, i.e., the reference potential layer 600, etc. Accordingly, a basic capacitance that is obtained through the pressure sensor 450 between the pressure sensor 450 and the reference potential layer 600 may be changed differently from that of the initial design. In this case, though the pressure touch occurs, the magnitude of the corresponding pressure cannot be accurately detected. Therefore, the pressure detection module 400 applied to the touch input device 1000 according to the embodiment of the present invention is able to perform a method for sensing the deformation and performing the correction.

For instance, in the state where no touch occurs on the touch input device 1000, a pressure detector 700 of the pressure detection module 400 applies the drive signal to the first electrode 450 and receives a signal including information on the capacitance from the first electrode 450, and then can correct the pressure detection accuracy if a difference value between the corresponding capacitance and the basic capacitance determined in the initial design is out of an error range.

FIG. 7b shows a cross section of a portion of the touch input device to which the pressure sensor of which the pressure detection accuracy can be corrected according to a second embodiment has been attached. Although FIG. 7b shows that two first electrodes 451 and 452 are included as the pressure sensor, a larger number of first electrodes can be included. Here, each of the first electrodes 451 and 452 may form individual channels. As with FIG. 7a, FIG. 7b shows that a portion of the reference potential layer 600 has been deformed (denoted by M).

Accordingly, a basic capacitance that is obtained through the pressure sensors 451 and 452 between the reference potential layer 600 and the pressure sensors 451 and 452 may be changed differently from that of the initial design. Therefore, the pressure detection accuracy for each of the pressure sensors 451 and 452 can be corrected in the same way as that described in FIG. 7a. That is, in the state where no touch occurs on the touch input device 1000, the pressure detector 700 measures a capacitance between the reference potential layer 600 and each of the first electrodes 451 and 452, and then can correct the pressure detection accuracy if a difference value between the corresponding capacitance and the basic capacitance determined in the initial design is out of an error range.

In a state where only a portion of the reference potential layer 600 is deformed (M), it may be easier to correct the accuracy by the plurality of electrodes 451 and 452 as shown in FIG. 7b than to correct the accuracy by only one electrode 450 as shown in FIG. 7a. More specifically, when the capacitance is detected by only one electrode 450, a ratio of the capacitance change due to the deformation M to the total capacitance value is low, so that the detection of the basic capacitance may not be relatively easy. In contrast, when the plurality of electrodes 451 and 452 are included, the area of each of the electrodes 451 and 452 may be smaller than that of using only one electrode 450. Therefore, when the capacitance is detected by the plurality of electrodes 451 and 452, a ratio of the capacitance change due to the deformation M to the total capacitance value detected from the electrode 451 that is affected by the deformation M is high, so that the detection of the basic capacitance may be relatively easy.

Also, according to the embodiment, the capacitance value detected from the electrode 452 that is not affected by the deformation M is used as a normal comparison group, thereby detecting whether the capacitance detected from the electrode 451 has been changed or not. FIG. 7b shows only one electrode 452 as a normal comparison group. However, according to the embodiment, when more than two electrodes are used, the capacitance detected from the plurality of electrodes 452 that is not affected by the deformation M is used as a normal comparison group can be used as a comparison group. Alternatively, the basic capacitance detected from a larger number of the electrodes 452 in the plurality of electrodes 451 and 452 may be determined as a normal reference capacitance, and the capacitance detected from a smaller number of the electrodes 451 may be determined as a correction target.

While, in the foregoing description, the example has been provided in which the reference potential layer 600 is deformed, the pressure detection accuracy correction technology of the present invention can be applied to a case where the capacitance which is formed between the reference potential layer 600 and the pressure sensors 450 and 460 in the touch input device becomes different from that of the initial design due to any reason, or can be applied to a case where the capacitance which is formed between the first electrode 450 and the second electrode 460 becomes different from that of the initial design.

When a touch with the pressure magnitude greater than a predetermined pressure magnitude occurs on the touch input device 1000, the touch may be recognized as a pressure touch. The pressure touch is distinguished from a tap touch which simply occurs on the touch surface of the touch input device 1000. After the touch is recognized as a pressure touch, the touch may be recognized differently according to a level of the pressure magnitude of the touch. Also, the pressure touch itself may be recognized as a meaningful input in the touch input device 1000. When the basic capacitance detected from the pressure sensors 450 and 460 in the touch input device 1000 is changed, a pressure sensitivity may be changed.

For example, as shown in FIGS. 7a and 7b, when the reference potential layer 600 and the pressure sensors 451 and 452 are deformed to get close to each other, the detected basic capacitance is increased and the pressure sensitivity is increased. Here, when the user presses by the same force, there occurs in the touch input device 1000 an effect that the user presses by a force greater than that before the deformation. Further, according to the embodiment, when the reference potential layer 600 and the pressure sensors 451 and 452 are deformed to get further from each other, the detected basic capacitance is decreased and the pressure sensitivity is reduced. Here, when the user presses by the same force, there occurs in the touch input device 1000 an effect that the user presses by a force less than that before the deformation. In other words, due to the deformation, the user feels the same feeling as if the user presses by a force greater/less than the force by which the user himself/herself used to press. Therefore, the input desired by the user cannot be performed on the touch input device 1000.

Therefore, when the basic capacitance detected as such from the pressure sensors 450, 451, and 452 is changed, it is necessary to correct the pressure detection accuracy of the touch input device 1000 so as to maintain an existing pressure sensitivity.

FIG. 8a is a plan view of the pressure sensor according to the first embodiment of the present invention. FIG. 8b is a plan view of the pressure sensor according to the second embodiment of the present invention. In FIG. 8a, the first one electrode 450 is included as the pressure sensor. The electrode 450 may be formed to be wide so as to correspond to the width of the touch screen. In FIG. 8b, a plurality of first electrodes 450 to 458 are included as the pressure sensor. The interval between the first electrodes 450 to 458 may be small such that the plurality of first electrodes 450 to 458 are combined to correspond to the width of the touch screen.

As shown in FIG. 8b, the plurality of first electrodes 450 to 458 may form a plurality of channels. For example, each of the plurality of first electrodes 450 to 458 may form one channel. As such, the pressure sensor is configured to form the plurality of channels, so that the detection accuracy of the pressure of a single touch can be improved and the multiple pressure of a multi touch can be detected.

For example, when the pressure sensor configured to form the plurality of channels detects the magnitude of the pressure of the single touch, a summed value or an average value of the pressure magnitudes (or capacitance values corresponding thereto) detected from the respective channels are used. Therefore, the detection accuracy of the pressure magnitude can be improved.

When the pressure sensor is configured to form the plurality of channels, the multiple pressure of the multi touch can be detected. This can be made by using the pressure magnitude detected from the channels of the pressure electrodes 450 and 460 disposed at position corresponding to each of the multiple touch positions obtained from the touch sensor panel 100. Alternatively, when the pressure sensor is configured to form the plurality of channels, the touch position can be directly detected by the pressure sensor. The multiple pressure can be detected by using the pressure magnitude obtained from the channel of the pressure electrodes 450 and 460 disposed at the corresponding position.

When the deformation M occurs, as shown in FIGS. 8a and 8b, in a portion, the capacitance change due to the deformation can be more easily detected from the relatively narrower electrodes 450 to 458 shown in FIG. 8b than the relatively wider electrode 450 shown in FIG. 8a. Here, since the electrodes 450 to 458 form the plurality of channels, a more precise correction of the mechanical deformation, etc., can be performed.

The pressure detection accuracy correction according to the embodiment of the present invention may be performed for each channel. For example, on the basis of a difference value between the basic capacitance that is detected from one channel and a predetermined basic capacitance, it is determined whether the correction is performed or not. If the correction is required, the correction may be performed for each channel. Alternatively, on the basis of a difference value between the basic capacitance that is detected from one channel and the basic capacitance detected from the other channels, it is determined whether the correction of the corresponding one channel is performed or not.

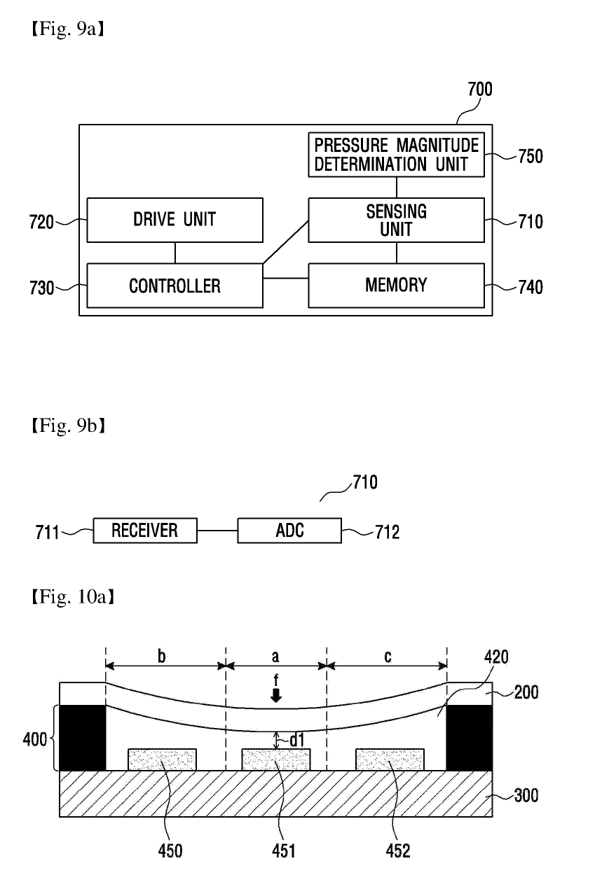

FIG. 9a shows the pressure detector according to the embodiment of the present invention. In this specification, the pressure detection module 400 may be designated to include the pressure sensor 450 and 460 and the pressure detector 700.

The pressure detector 700 according to the embodiment may include a sensing unit 710, a drive unit 720, a controller 730, and a correction unit 740. The drive unit 720 and the sensing unit 710 included in the pressure detector 700 may operate in the same manner as or a similar manner to that of the drive unit 120 and the sensing unit 110 of the touch sensor panel 100, which has been described with reference to FIG. 1. A drive signal may be applied to the each of the electrodes 450 to 458 through the drive unit 720. The sensing unit 710 may receive a signal including information on the capacitance from the each of the electrodes 450 to 458.

FIG. 9b shows a configuration of the sensing unit 710 according to the embodiment. The sensing unit 710 of the pressure detector 700 according to the embodiment of the present invention may have the same or similar configuration as/to that of the sensing unit 110 described with reference to FIG. 1. The sensing unit 710 according to the embodiment may include a receiver 711 and an analog-digital converter (ADC) 712. The receiver 711 may transfer a signal including the capacitance change generated at the pressure sensor 450 and 460 to the ADC 712. Here, the capacitance change may correspond to a capacitance change generated at the pressure sensor 450 and 460 or a capacitance change generated between the pressure sensor 450 and 460 and the reference potential layer 600 by applying a pressure to the touch surface of the touch input device 1000. The signal may be an analog voltage signal.

The ADC 712 included in the sensing unit 710 converts the analog signal including information on the capacitance into a digital signal. A pressure magnitude determination unit 750 which may be included in the pressure detector 700 according to the embodiment is able to determine the magnitude of the pressure on the basis of a value of the digital signal. For example, it can be assumed that, in the initial design, the digital signal value output from the ADC 712 is changed from 0 to 100. Here, the digital signal value corresponds to the basic capacitance can be 10. A processor (not shown) may process such that an input operation corresponding to the pressure magnitude is performed in the touch input device 1000 in accordance with the result of the pressure magnitude determination unit 750. According to the embodiment, the pressure magnitude determination unit 750 may be included in the processor (not shown). According to the embodiment, the pressure magnitude determination unit 750 may be included in the central processing unit (CPU) or application processor (AP) of the touch input device 1000.

The controller 730 may operate the drive unit 720 and the sensing unit 710 in such a way as to start a process for determining whether the pressure detection accuracy correction is required or not. The pressure detection accuracy correction method may be manually performed by the user's input of the touch input device 1000 or automatically performed at a preset time. Hereinafter, the pressure detection accuracy correction process will be described in detail.

In the pressure detection accuracy correction process, a drive signal is applied to respective electrodes 450 to 458 through the drive unit 720 in the state where no touch occurs on the touch input device 1000. The sensing unit 710 may receive a signal including information on the capacitance from each of the electrodes 450 to 458. The sensing unit 710 may output information on the basic capacitance between the electrodes 450 to 458 and the reference potential layer 600. Here, the controller 730 may determine whether a difference value between the measured basic capacitance output from the sensing unit 710 and the basic capacitance as a predetermined reference value deviates from a predetermined error range or not. If the difference value does not deviate from the predetermined error range, the controller 730 determines that the pressure detection accuracy correction method is not required and does not perform the subsequent correction process. If the difference value deviates from the predetermined error range, the controller 730 determines that the pressure detection accuracy correction method is required, and thus, performs the subsequent correction process.

For example, the output digital signal value of the ADC 712, which corresponds to the basic capacitance that is measured, may be changed to 5 due to the deformation, etc. This is an example in which the pressure sensitivity is reduced because the distance between the pressure sensors 450 to 458 and the reference potential layer 600 is increased. In this case, when the user presses by the same force by which the user used to press before the deformation, the controller 730 corrects in such a way that the output of the ADC 712 is multiplied by a predetermined factor and is transferred to the pressure magnitude determination unit 750 in order that the pressure is determined as the same magnitude before the deformation. In the above example, the factor may be set to 2 such that the pressure magnitude determination unit 750 determines the pressure magnitude on the basis of existing determination criterion without being modified or changed. Therefore, the result value obtained by multiplying the digital signal value output from the ADC 712 by the factor of 2 may be input to the pressure magnitude determination unit 750. Accordingly, when the touch surface of the touch input device 1000 is pressed by a force equal to that before the deformation, the digital signal value output from the ADC 712 becomes smaller. However, the corresponding digital signal value is multiplied by the factor of 2 and is input to the pressure magnitude determination unit 750, and thus, the magnitude of the corresponding pressure may be detected the same as that before the deformation. That is, even though the pressure detection sensitivity of the touch input device 1000 is reduced due to the deformation, the correction is made by multiplying the output digital signal value of the ADC 712 by the factor of 2, so that, with respect to the same force of the user before and after the deformation, the pressure magnitude determination unit 750 may determine that both of the pressure magnitudes are the same.

Similarly, the output digital signal value of the ADC 712, which corresponds to the basic capacitance that is measured, may be changed to 20 due to the deformation, etc. This is an example in which the pressure sensitivity is increased because the distance between the pressure sensors 450 to 458 and the reference potential layer 600 is decreased. In this case, when the user presses by the same force by which the user used to press before the deformation, the controller 730 corrects in such a way that the output of the ADC 712 is multiplied by a predetermined factor and is transferred to the pressure magnitude determination unit 750 in order that the pressure is determined as the same magnitude before the deformation. In the above example, the factor may be set to ½ such that the pressure magnitude determination unit 750 determines the pressure magnitude on the basis of existing determination criterion without being modified or changed. Therefore, the result value obtained by multiplying the digital signal value output from the ADC 712 by the factor of ½ may be input to the pressure magnitude determination unit 750. Accordingly, when the touch surface of the touch input device 1000 is pressed by a force equal to that before the deformation, the digital signal value output from the ADC 712 becomes larger. However, the corresponding digital signal value is multiplied by the factor of ½ and is input to the pressure magnitude determination unit 750, and thus, the magnitude of the corresponding pressure may be detected the same as that before the deformation. That is, even though the pressure detection sensitivity of the touch input device 1000 is increased due to the deformation, the correction is made by multiplying the output digital signal value of the ADC 712 by the factor of ½, so that, with respect to the same force of the user before and after the deformation, the pressure magnitude determination unit 750 may determine that all of the pressure magnitudes are the same.

When the pressure detection accuracy correction is made, the controller 730 may store the corresponding setting in a memory 740 and transfer a control signal to the sensing unit 710.

That is to say, when the pressure detection accuracy correction is made, the controller 730 may calculate the value of the factor and store in the memory 740. When the pressure detection accuracy correction is not made, the factor that is multiplied to the ADC 712 may be designated as 1 and stored in the memory 740. The controller 730 according to the embodiment of the present invention may store the pressure detection accuracy correction items in the memory 740. According to the embodiment, the controller 730 may calculate the above-described factor value according to the pressure detection accuracy correction and store in the memory 740. The controller 730 may control such that the result value obtained by multiplying the output digital signal value of the ADC 712 by the factor is inputted to the pressure magnitude determination unit 750. Also, the controller 730 may control such that the pressure magnitude determination unit 750 determines the pressure magnitude on the basis of the result value obtained by multiplying the output digital signal value of the ADC 712 by the factor. According to the embodiment, the controller 730 and/or the sensing unit 710 may operate with reference to the memory 740. According to the embodiment, the controller 730 may be the central processing unit (CPU) or application processor (AP) of the touch input device 1000.

According to the embodiment, the touch sensing IC in which the pressure detector 700 for the operation of the pressure detection has been implemented can be further included in the touch input device 1000. In this case, the touch input device 1000 includes repeatedly, as shown in FIG. 1, a configuration similar to the configuration including the drive unit 120, the sensing unit 110, and the controller 130, so that there may occur a problem that the area and volume of the touch input device 1000 are increased. According to the embodiment, through the touch detection device for the operation of the touch sensor panel 100, the touch input device 1000 applies the drive signal to the pressure sensor for the pressure detection and receives the sensing signal from the pressure sensor for the pressure detection, thereby detecting the touch pressure.

For this, the controller 130 in the touch input device 1000 according to the embodiment of the present invention may perform not only the scanning of the touch sensor panel 100 but also the scanning of the pressure detection. Alternatively, the controller 130 may generate a control signal in such a manner as to, through time-sharing, perform the scanning of the touch sensor panel 100 in a first time interval and to perform the scanning of the pressure detection in a second time interval different from the first time interval.

As such, through the touch pressure detection accuracy correction, the uniform pressure detection accuracy in the entire touch screen of the touch input device 1000 can be obtained. Also, the user is able to operate the touch input device 1000 with the same pressure sensitivity in spite of the mechanical deformation of the touch input device 1000.

Although the foregoing has described the method of correcting the pressure detection accuracy on the basis of the self-capacitance between the reference potential layer and the pressure sensor composed of the first electrodes 450 to 458, it is also apparent that the correction method can be performed on the basis of the mutual capacitance between the first electrode 450 and the second electrode 460 in the state where the pressure sensor including at least one pair of the first electrode 450 and the second electrode 460.

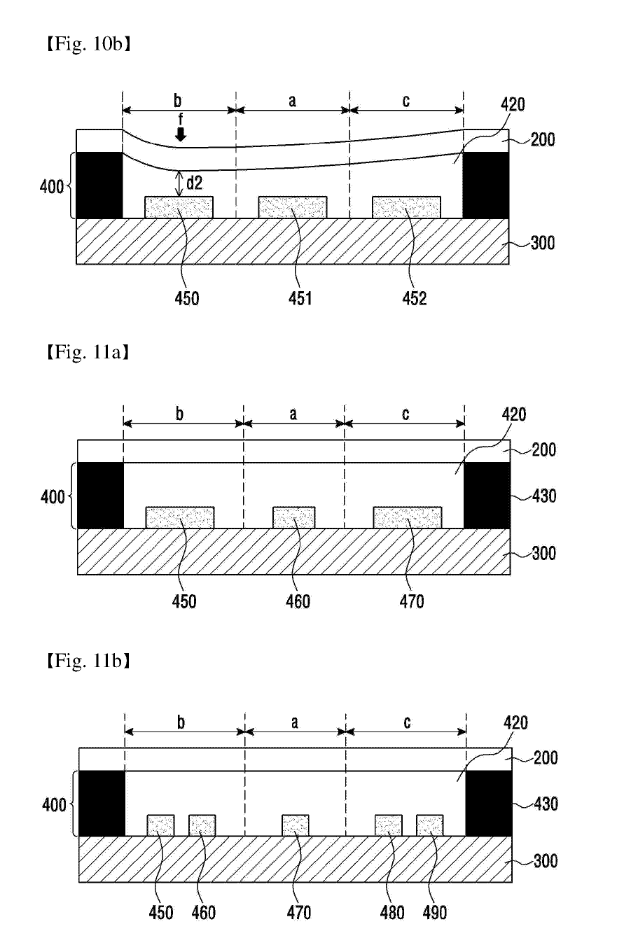

FIGS. 10a and 10b are cross sectional views of a portion of the touch input device in which non-uniformity of the pressure detection accuracy may occur. FIGS. 10a and 10b show that the pressure sensor is attached to the substrate 300 and the display module 200 serves as the reference potential layer.

For example, when a pressure is applied to the touch screen of the touch input device 1000 by the object, how much the touch sensor panel 100 and the display module 200 are bent changes depending on where the pressure is applied. Therefore, even though a pressure is applied, the magnitude of the touch pressure may be detected differently depending on the position to which the pressure is applied.

For example, when a pressure is, as shown in FIGS. 10a and 10b, applied to the display module 200 in the touch input device 1000 according to the embodiment of the present invention, a first area “a” of the display module 200 may be bent more than second areas “b” and “c”. Therefore, a distance d2 between the display module 200 and the pressure electrodes 450 and 452 disposed on the lower portions of the second areas “b” and “c” when the pressures having the same magnitude are applied to the second areas “b” and “c” of the display module 200 may be greater than a distance d1 between the display module 200 and the pressure electrode 451 disposed on the lower portion the first area “a” when the pressure is applied to the first area “a” of the display module 200.

In other words, the pressure electrodes are, as shown in FIGS. 10a and 10b, formed on the substrate 300 in such a way as to have the same width at a regular interval. When the pressure electrodes are spaced apart from the reference potential layer at the same distance and are formed to have the same composition as that of the reference potential layer, even though the pressures having the same magnitude are applied, the change amount of the capacitance detected in the second areas “b” and “c” of the display module 200 may be larger than the change amount of the capacitance detected in the first area “a” of the display module 200.

Therefore, when the object applies pressures having the same magnitude to the touch sensor panel 100, in order to detect the touch pressures having the same magnitude irrespective of where the pressure is applied, there is a necessity to arrange the pressure electrodes such that the capacitance change amount detected in the second areas “b” and “c” of the display module 200 is larger than the capacitance change amount detected in the first area “a” of the display module 200.

In other words, when a pressure is applied to the touch sensor panel 100, the distance between the display module 200 and the substrate 300 changes, and under the condition of the same distance change, there is a necessity to arrange the pressure electrodes such that the capacitance change amount detected at the pressure electrode disposed on the lower portion of the second area of the display module 200 is larger than the capacitance change amount detected at the pressure electrode disposed on the lower portion of the first area of the display module 200.

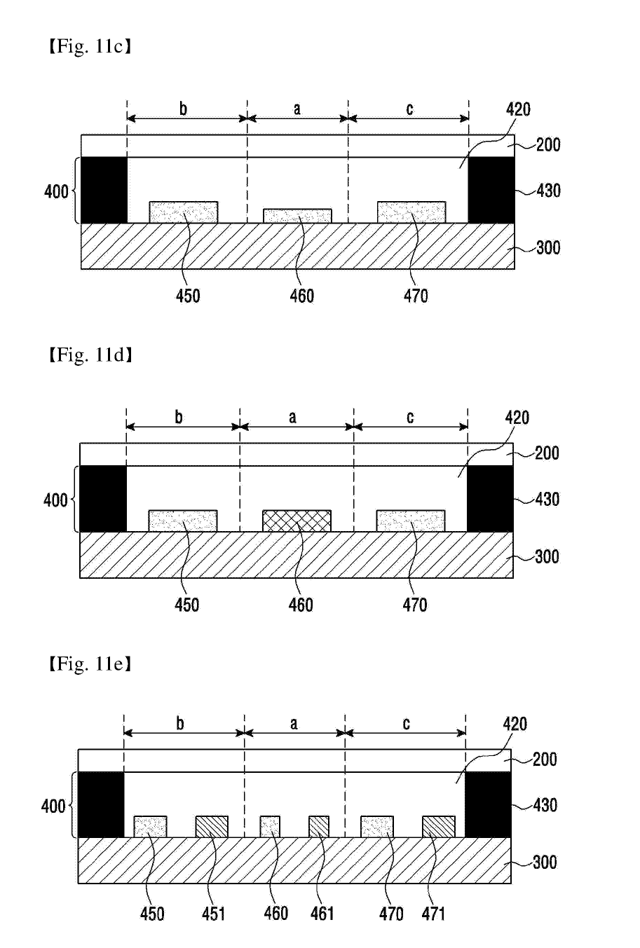

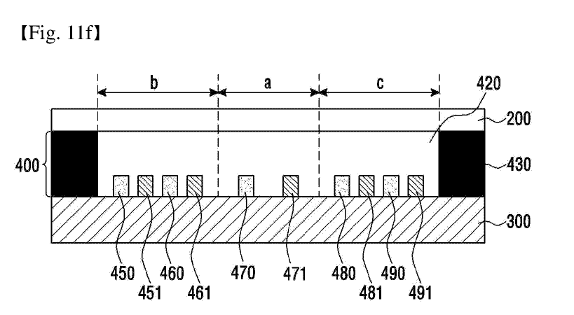

For instance, as shown in FIG. 11a, in order that the change amount of the capacitance detected in the second areas “b” and “c” of the display module 200 is larger than the change amount of the capacitance detected in the first area “a” of the display module 200, the width of the pressure electrode 460 disposed on the lower portion of the first area “a” may be less than the widths of the pressure electrodes 450 and 470 disposed on the lower portions of the second areas “b” and “c”.

According to the embodiment, as shown in FIG. 11b, the distance between the pressure electrode 470 disposed on the lower portion of the first area “a” and the pressure electrode adjacent to the pressure electrode 470 may be greater than the distance between the pressure electrodes 450 and 460 disposed on the lower portions of the second area “b” and “c” and the electrode adjacent to the pressure electrodes 450 and 460.

According to the embodiment, as shown in FIG. 11c, the distance between the reference potential layer and the pressure electrode 460 disposed on the lower portion of the first area “a” may be greater than the distance between the reference potential layer and the pressure electrodes 450 and 470 disposed on the lower portions of the second areas “b” and

According to the embodiment, as shown in FIG. 11d, the composition of the material constituting the pressure electrode 460 disposed on the lower portion of the first area “a” may be different from the composition of the material constituting the pressure electrodes 450 and 470 disposed on the lower portions of the second areas “b” and “c”.

The foregoing has described the embodiment in which, when the pressure sensor is comprised of a single electrode for the detection of the self-capacitance, the change amount of the capacitance detected in the first area “a” of the display panel 200 is greater than the change amount of the capacitance detected in the second areas “b” and “c” in accordance with the first to fourth methods. An embodiment in which, when the pressure sensor includes the first electrode and the second electrode which are for the detection of the mutual capacitance, the capacitance change amount detected in the second area “b” or “c” of the display module 200 is greater than the capacitance change amount detected in the first area “a” will be described with reference to FIGS. 11e to 11f.

For example, as shown in FIG. 11e according to the first method, when the pressure electrode is comprised of the first electrodes 450, 460, and 470 and the second electrodes 451, 461, and 471, the widths of the first electrode 460 and the second electrode 461 which are disposed on the lower portion of the first area “a” may be less than the widths of the first electrodes 450 and 470 and the second electrodes 451 and 461 which are disposed on the lower portions of the second areas “b” and “c”.

For example, as shown in FIG. 11f, when the pressure electrode is comprised of the first electrodes 450, 460, 470, and 480 and the second electrodes 451, 461, 471, and 481, a distance between the adjacent electrodes of first electrode 470 and the second electrode 471 disposed on the lower portion of the first area “a” may be larger than a distance between adjacent electrodes of the first and second electrodes 450, 460, 480, 490, 451, 461, 481, and 491 disposed on the lower portions of the second areas “b” and “c”.

Also, when the pressure sensor includes, as described above, the first electrode and the second electrode which are for the detection of the mutual capacitance, the change amount of the capacitance detected in the second areas “b” and “c” may be intended to be greater than the change amount of the capacitance detected in the first area “a”, similarly to the description of FIGS. 11c and 11d.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

### INDUSTRIAL APPLICABILITY

The embodiment of the present invention can provide the pressure detection accuracy correction method capable of improving the pressure detection accuracy of the touch in the touch input device and can provide the pressure detector performing the same.

The embodiment of the present invention can provide the touch input device including the pressure detector performing the pressure detection accuracy correction method.

According to the embodiment of the present invention, it is possible to prevent the pressure detection accuracy from being degraded due to the deformation of the component, etc., of the touch input device.

According to the embodiment of the present invention, it is possible to provide the pressure detection module capable of improving the signal to noise ratio (SNR) at the time of detecting the pressure.

According to the embodiment of the present invention, it is possible to improve the pressure detection uniformity.

1. A touch input device comprising:
a pressure sensor; and
a pressure detector,
wherein the pressure detector comprises:
a drive unit which applies a drive signal to the pressure sensor;
a sensing unit which receives a signal from the pressure sensor and detects a capacitance generated at the pressure sensor;
a pressure magnitude determination unit which determines a pressure magnitude on the basis of a signal input from the sensing unit; and
a controller which performs correction for changing the capacitance corresponding to a predetermined pressure magnitude determined by the pressure magnitude determination unit.

2. The touch input device of claim 1, wherein, in a state where no touch occurs on the touch input device, the correction is performed if a difference value between a capacitance value that is output from the sensing unit and a reference capacitance value is greater than a predetermined error value.

3. The touch input device of claim 1, wherein the pressure sensor comprises a plurality of electrodes constituting a plurality of channels, and wherein the correction is performed for each of the plurality of channels.

4. The touch input device of claim 1, wherein a factor determined according to the correction is multiplied to an output signal of the sensing unit and then is input to the pressure magnitude determination unit.

5. The touch input device of claim 4, wherein the sensing unit comprises a receiver and an analog to digital converter (ADC), and wherein the output signal of the sensing unit is an output signal of the ADC.

6. The touch input device of claim 1, wherein the pressure sensor comprises at least one pair of a first electrode and a second electrode, and wherein the signal received from the pressure sensor comprises information on a mutual capacitance value between the first electrode and the second electrode.

7. The touch input device of claim 1, wherein the signal received from the pressure sensor comprises information on a self-capacitance value between the pressure sensor and a reference potential layer, and wherein the pressure sensor comprises at least one single electrode.ds

8. A pressure detector comprising:
a drive unit which applies a drive signal to a pressure sensor;
a sensing unit which receives a signal from the pressure sensor and detects a capacitance generated at the pressure sensor;
a pressure magnitude determination unit which determines a pressure magnitude on the basis of a signal input from the sensing unit; and
a controller which performs correction for changing the capacitance corresponding to a predetermined pressure magnitude determined by the pressure magnitude determination unit.

9. The pressure detector of claim 8, wherein, in a state where no touch occurs on the touch input device to which the pressure sensor is attached, the correction is performed if a difference value between a capacitance value that is output from the sensing unit and a reference capacitance value is greater than a predetermined error value.

10. The pressure detector of claim 8, wherein the pressure sensor comprises a plurality of electrodes constituting a plurality of channels, and wherein the correction is performed for each of the plurality of channels.

11. The pressure detector of claim 8, wherein a factor determined according to the correction is multiplied to the output signal of the sensing unit and then is input to the pressure magnitude determination unit.

12. The pressure detector of claim 11, wherein the sensing unit comprises a receiver and an analog to digital converter (ADC), and wherein the output signal of the sensing unit is an output signal of the ADC.

13. The pressure detector of claim 8, wherein the pressure sensor comprises at least one pair of a first electrode and a second electrode, and wherein a signal received from the pressure sensor comprises information on a mutual capacitance value between the first electrode and the second electrode.

14. The pressure detector of claim 8, wherein a signal received from the pressure sensor comprises information on a self-capacitance value between the pressure sensor and a reference potential layer, and wherein the pressure sensor comprises at least one single electrode.

15. The touch input device of claim 1, wherein the correction is performed if a difference value between a capacitance value that is output from the sensing unit and a reference capacitance value is greater than a predetermined error value.

16. The touch input device of claim 8, wherein the correction is performed if a difference value between a capacitance value that is output from the sensing unit and a reference capacitance value is greater than a predetermined error value.
